(19) United States
(12) Patent Application Publication
(10) Pub. No.: US 2017/0070845 A1
(43) Pub. Date: Mar. 9, 2017

(54) SYSTEMS, METHODS AND ARTICLES TO PROVIDE OLFACTORY SENSATIONS

(71) Applicant: VAPOR COMMUNICATIONS, INC., Cambridge, MA (US)

(72) Inventors: David A. EDWARDS, Boston, MA (US); Rachel Diane FIELD, Huntington Beach, CA (US)

(21) Appl. No.: 15/121,938

(22) PCT Filed: Oct. 15, 2014
(86) PCT No.: PCT/US2014/060643

§ 371 Date: Aug. 26, 2016

Related U.S. Application Data
(60) Provisional application No. 61/944,870, filed on Feb. 26, 2014.

(51) Int. Cl. H04W 4/00; H04L 29/08; B05B 12/12; H04W 4/12; B05B 7/00; B05B 12/14; H04W 76/02; H04W 4/02

(52) U.S. Cl. CPC H04W 4/008; H04W 76/023; H04L 67/06; H04W 4/023; H04W 4/12; B05B 7/0081; B05B 12/14; B05B 12/122

(57) ABSTRACT

Systems and methods for dispensing scents. A beacon transmits short-range wireless signals to detect mobile devices located proximate to the beacon. The beacon transmits scent messages to users of the mobile devices providing the users with opportunities for experiencing one or more scents on a scent dispensing device. The scent dispensing device receives scent dispensing instructions from one or more computing devices. The scent messages may include product information, product advertisements, and/or instructions to assist a user to locate a scent dispensing device.

### BACKGROUND

Technical Field

The present disclosure relates generally to the selective dispensing of combinations and sequences scents that are specified in scent specifications.

Description of the Related Art

The sense of smell (i.e., olfactory perception) is extremely important to humans. For example, the smell of smoke can alert a person of the potential dangers of a nearby fire. Additionally, smells can trigger memories and impact our emotions. Various forms of aromatherapy have been investigated in attempts to alter a person's mind, mood, cognitive function, and/or health.

A number of systems and devices have been developed for selectively providing olfactory sensations. For a variety of reasons, such systems and devices have proven to be inadequate and have not gained commercial acceptance. For example, the Smell-O-Vision system was developed over fifty years ago, which caused a number of different odors to be emitted from the seats in a movie theater when triggered by a film's soundtrack. That system was expensive and had technical problems. Accordingly, the Smell-O-Vision system was used in conjunction with only one film.

New approaches that enable users to quickly and easily generate customized scent specifications for communicating specific themes, ideas, and/or feelings using sequences and combinations of scents are desirable. Additionally, new systems and devices that dispense scents based on such scent specifications are desirable.

### BRIEF SUMMARY

A method to provide a scent to a user may be summarized as including: moving a client device in proximity to a beacon that transmits a short-range wireless signal, the client device communicates with a scent dispensing device over a scent dispensing device communications interface; detecting the short-range wireless signal transmitted by the beacon at the client device using a short-range wireless communications interface; establishing a link over the short-range wireless communications interface between the client device and the beacon; and receiving a scent specification file from the beacon at the client device over the link, the scent specification file specifying at least one scent.

The method may further include causing scent dispensing instructions to be sent from the client device to the scent dispensing device based on the scent specification file over the scent dispensing device communications interface, the scent dispensing instructions usable by the scent dispensing device to dispense the specified at least one scent. Causing the scent dispensing instructions to be sent from the client device to the scent dispensing device over the scent dispensing device communications interface may include causing the scent dispensing instructions to be sent wirelessly. The method may further include receiving a message from the beacon at the client device over the link, the message including at least one of advertising information or product information.

A method to provide a scent to a user may be summarized as including: providing a beacon that transmits a short-range wireless signal using a short-range wireless communications interface; determining that a mobile device is in proximity to the beacon; and sending a scent notification message wirelessly to the mobile device, the scent notification message providing a notification for a user of the mobile device that at least one scent is available to be experienced by the user.

The method may further include causing the at least one scent to be dispensed at a scent dispensing device so that the at least one scent is experienced by the user. Sending a scent notification message may include sending a scent notification message that includes instructions for the user to locate a scent dispensing device. Determining that the mobile device is in proximity to the beacon may include: transmitting a short-range wireless signal from the beacon; and receiving a short-range wireless signal at the beacon from the mobile device responsive to transmitting the short-range wireless signal from the beacon. Determining that the mobile device is in proximity to the beacon may include: detecting a location of the mobile device using a global positioning system (GPS) associated with the mobile device.

A method to provide a scent to a user may be summarized as including: sending a scent notification message wirelessly to a mobile device, the scent notification message providing a notification for a user of the mobile device that at least one scent is available to be experienced by the user; detecting that the user is in proximity to a scent dispensing device; and causing the scent dispensing device to dispense the at least one available scent.

Sending a scent notification message wirelessly may include sending a text message to the mobile device. Sending a scent notification message wirelessly may include sending a notification message through an application installed on a data storage of the mobile device. Detecting that the user is in proximity to a scent dispensing device may include receiving a signal at the scent dispensing device from the mobile device of the user. Detecting that the user is in proximity to a scent dispensing device may include receiving a code at the scent dispensing device from the user of the mobile device. Detecting that the user is in proximity to a scent dispensing device may include detecting a location of the mobile device using a global positioning system (GPS) associated with the mobile device. Sending a scent notification message wirelessly may include sending a scent notification that includes instructions for locating the scent dispensing device. Sending a scent notification message wirelessly may include sending a scent notification that includes at least one of advertising information or product information.

A method to provide a scent to a user may be summarized as including: providing a scent dispensing device that dispenses one or more scents; sending a scent notification message wirelessly to a mobile device, the scent notification message providing a notification for a user of the mobile device that at least one scent is available to be experienced by the user at the scent dispensing device; and causing the scent dispensing device to dispense the at least one available scent.

The method may further include: receiving location information for the mobile device; wherein sending a scent notification message wirelessly to a mobile device includes sending a scent notification message wirelessly to the mobile device dependent on the received location information. Receiving location information for the mobile device may include: transmitting a short-range wireless signal from a beacon; and receiving a short-range wireless signal at the beacon from the mobile device responsive to transmitting the short-range wireless signal from the beacon. Receiving location information for the mobile device may include: receiving global positioning system (GPS) data associated with the mobile device. Providing a scent dispensing device that dispenses one or more scents may include: providing an enclosed space; and positioning the scent dispensing device within the enclosed space. The method may further include: from time to time purifying the air in the enclosed space to remove one or more scents previously dispensed from the scent dispensing device. Sending a scent notification message wirelessly to a mobile device may include sending a scent notification message that includes a code, and the method further may further include: receiving the code from at least one of the user or the mobile device; and verifying the code; wherein causing the scent dispensing device to dispense the at least one available scent includes causing the scent dispensing device to dispense the at least one available scent dependent on a value of the code. The method may further include: storing an identifier in a data storage, the identifier uniquely identifying at least one of the user or the mobile device.

An apparatus may be summarized as including: an enclosure sized and dimensioned to receive a human user therein; a scent dispensing device positioned to dispense one or more scents within the enclosure; a user interface including a display; a processor operatively coupled to the user interface and the scent dispensing device; and a computer-readable storage medium that stores instructions that, when executed by the processor, cause the processor to: present an available scent identifier on the display of the user interface, the scent identifier specifying at least one scent; receive a selection of the scent identifier via the user interface; and cause the scent dispensing device to dispense the at least one scent specified by the selected scent identifier.

The processor may be operatively coupled to the scent dispensing device via a short-range wireless interface. The processor, user interface, and computer-readable storage medium may be disposed in a first housing, and the scent dispensing device may be disposed in a second housing different from the first housing. The processor, user interface, and computer-readable storage medium may be components of a mobile computing device. The apparatus may further include an air purification system that purifies the air within the enclosure to remove one or more scents dispensed by the scent dispensing device. The scent identifier may include at least one of a text portion, video portion, or audio portion. The scent identifier may include an image of a product, and the at least one scent specified by the scent identifier may be associated with the product. The apparatus may further include: a wireless communications interface operatively coupled to the processor, wherein the instructions cause the processor to: detect that a mobile device is located in proximity to the scent dispensing device; and send a scent notification message wirelessly to the mobile device when the mobile device is located in proximity to the scent dispensing device, the scent notification message provides a notification for a user of the mobile device that at least one scent is available to be experienced by the user at the scent dispensing device.

A scent notification system may be summarized as including: a beacon that transmits short-range wireless signals; a processor operatively coupled to the beacon and operatively coupled to a communications network; and a computer-readable storage medium that stores instructions that, when executed by the processor, cause the processor to: detect that a mobile device is in proximity to the beacon; and send a scent notification message wirelessly to the mobile device over the communications network, the scent notification message provides a notification for a user of the mobile device that at least one scent is available to be experienced by the user.

The instructions may cause the processor to cause the at least one scent to be dispensed at a scent dispensing device so that the at least one scent is experienced by the user. The instructions may cause the processor to send a scent notification message that includes instructions for the user to locate a scent dispensing device. The instructions may cause the processor to: transmit a short-range wireless signal from the beacon; and receive a short-range wireless signal at the beacon from the mobile device responsive to transmitting the short-range wireless signal from the beacon.

A scent notification system may be summarized as including: a processor operatively coupled to a communications network; and a computer-readable storage medium that stores instructions that, when executed by the processor, cause the processor to: send a scent notification message wirelessly to a mobile device, the scent notification message providing a notification for a user of the mobile device that at least one scent is available to be experienced by the user; detect that the user is in proximity to a scent dispensing device; and cause the scent dispensing device to dispense the at least one available scent.

The instructions may cause the processor to send a text message to the mobile device. The instructions may cause the processor to send a notification message through an application installed on a data storage of the mobile device.

### BRIEF DESCRIPTION OF THE SEVERAL VIEWS OF THE DRAWINGS

FIG. 1A is an isometric view of a scent dispensing device, according to one illustrated embodiment.

FIG. 1B is an exploded view of the scent dispensing device of FIG. 1A.

FIG. 2A is an isometric view of a scent emitter, according to one illustrated embodiment.

FIG. 2B is an exploded view of the scent emitter of FIG. 2A.

FIG. 3A is a front elevational view of a first diffuser part, according to one illustrated embodiment.

FIG. 3B is a rear elevational view of the first diffuser part of FIG. 3A.

FIG. 3C is a top plan view of the first diffuser part of FIG. 3A, with a fan attached thereto.

FIG. 4 is a front elevational view of a second diffuser part, according to one illustrated embodiment.

FIG. 5A is a front elevational view of a scent mixing chamber according to one illustrated embodiment.

FIG. 5B is a bottom plan view of the scent mixing chamber of FIG. 5A.

FIG. 6A is a top plan view of an upper shelf of the scent dispensing device of FIG. 1A.

FIG. 6B is an enlarged view of a portion of the upper shelf of FIG. 6A.

FIG. 7A is a side elevational view of a motor, according to one illustrated embodiment.

FIG. 7B is a top plan view of the motor of FIG. 7A.

FIG. 8A is a top plan view of a lower shelf of the scent dispensing device of FIG. 1A.

FIG. 8B is an enlarged view of a portion of the lower shelf of FIG. 8A.

FIG. 9A is a front elevational view of a scent cartridge, according to one illustrated embodiment.

FIG. 9B is cross-sectional view taken along line I-I of FIG. 9A.

FIG. 9C is a top plan view the scent cartridge of FIG. 9A.

FIG. 9D is top plan view of the scent cartridge of FIG. 9A, with an end portion thereof removed.

FIG. 10A is an isometric view of a scent dispensing device according to one illustrated embodiment.

FIG. 10B is a partially exploded view of the scent dispensing device of FIG. 10A.

FIG. 10C is another partially exploded view of the scent dispensing device of FIG. 10A.

FIG. 10D is cross-sectional view taken along line II-II of FIG. 10A.

FIG. 10E is bottom plan view of a scent mixing chamber of the scent dispensing device of FIG. 10A.

FIG. 11A is a top plan view of a scent cartridge holder of the scent dispensing device of FIG. 10A.

FIG. 11B is an isometric view of the scent cartridge holder of FIG. 11A.

FIG. 12A is an isometric view of a scent cartridge of the scent dispensing device of FIG. 10A.

FIG. 12B is a partially exploded view of the scent cartridge of FIG. 12A.

FIG. 12C is a bottom plan view of the scent cartridge of FIG. 12A.

FIG. 13A is a horizontal slice view taken along line III-III of FIG. 12A, according to one illustrated embodiment.

FIG. 13B is a horizontal slice view taken along line III-III of FIG. 12A, according to one illustrated embodiment.

FIG. 13C is a horizontal slice view taken along line III-III of FIG. 12A, according to one illustrated embodiment.

FIG. 13D is a horizontal slice view taken along line III-III of FIG. 12A, according to one illustrated embodiment.

FIG. 13E is a horizontal slice view taken along line III-III of FIG. 12A, according to one illustrated embodiment.

FIG. 13F is a horizontal slice view taken along line III-III of FIG. 12A, according to one illustrated embodiment.

FIG. 14A is an isometric view of an end portion of a scent cartridge, according to one illustrated embodiment.

FIG. 14B is an exploded view of the end portion of the scent cartridge of FIG. 14A.

FIG. 14C is a bottom plan view of a hermetically sealed membrane of the end portion of the scent cartridge of FIG. 14A, according to one illustrated embodiment.

FIG. 15A an exploded view of a scent cartridge pouch, according to one illustrated embodiment.

FIG. 15B is an exploded view of a scent cartridge blister pack, according to one illustrated embodiment.

FIG. 16 is a network diagram of a scent dispensing system according to one illustrated embodiment.

FIGS. 17A-17F illustrate a schematic diagram of a scent dispensing device, according to one illustrated embodiment.

FIG. 18 is a block diagram of a mobile device, according to one illustrated embodiment.

FIG. 19 is a block diagram of a server, according to one illustrated embodiment.

FIG. 20 is block diagram of a scent sequence specification user interface, according to one illustrated embodiment.

FIG. 21 is a flowchart of a method of operating a scent dispensing system, according to one illustrated embodiment.

FIG. 22 is a flowchart of a method of operating a scent dispensing system, according to one illustrated embodiment.

FIG. 23 is a flowchart of a method of operating a scent dispensing system, according to one illustrated embodiment.

FIG. 24A is a top plan view of a scent cartridge, according to one illustrated embodiment.

FIG. 24B is a top plan view of the scent cartridge of FIG. 24A rotated clockwise by 144°.

FIG. 24C is a top plan view of the scent cartridge of FIG. 24B rotated clockwise by 72°.

FIG. 25 is a network diagram of a scent dispensing system, according to one illustrated embodiment.

FIG. 26 is a flowchart of a method of operating a scent dispensing system, according to one illustrated embodiment.

FIG. 27 is a flowchart of a method of operating a scent dispensing system, according to one illustrated embodiment.

FIG. 28 is a flowchart of a method of operating a scent dispensing system, according to one illustrated embodiment.

FIG. 29 is a flowchart of a method of operating a scent dispensing system, according to one illustrated embodiment.

FIG. 30 is a network diagram of a scent dispensing system, according to one illustrated embodiment.

### DETAILED DESCRIPTION

In the following description, certain specific details are set forth in order to provide a thorough understanding of various disclosed embodiments. However, one skilled in the relevant art will recognize that embodiments may be practiced without one or more of these specific details, or with other methods, components, materials, etc. In other instances, well-known structures associated with microcontrollers, motor devices, power supplies such as DC/DC converters, wireless radios (i.e., transmitters, receivers or transceivers), computing systems including client and server computing systems, and networks (e.g., cellular, packet switched), as well as other communications channels, have not been shown or described in detail to avoid unnecessarily obscuring descriptions of the embodiments.

Unless the context requires otherwise, throughout the specification and claims which follow, the word “comprise” and variations thereof, such as, “comprises” and “comprising” are to be construed in an open, inclusive sense, that is, as “including, but not limited to.”

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

The headings and Abstract of the Disclosure provided herein are for convenience only and do not interpret the scope or meaning of the embodiments.

The structure of various embodiments of a scent dispensing device will be described first. A scent dispensing system will then be described. The structure of various components of scent dispensing system will be described next. Several examples of operating of the scent dispensing system will then be described.

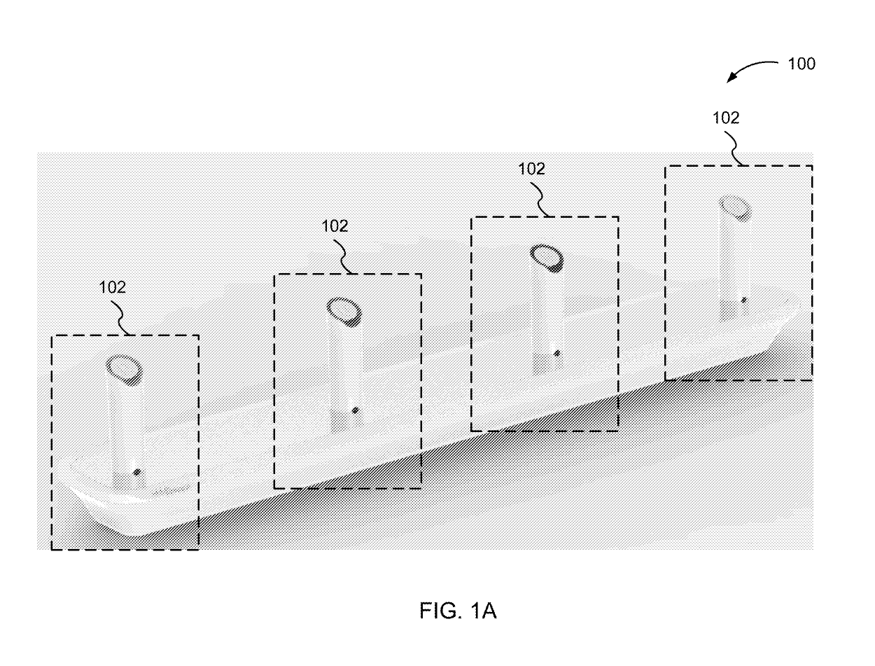

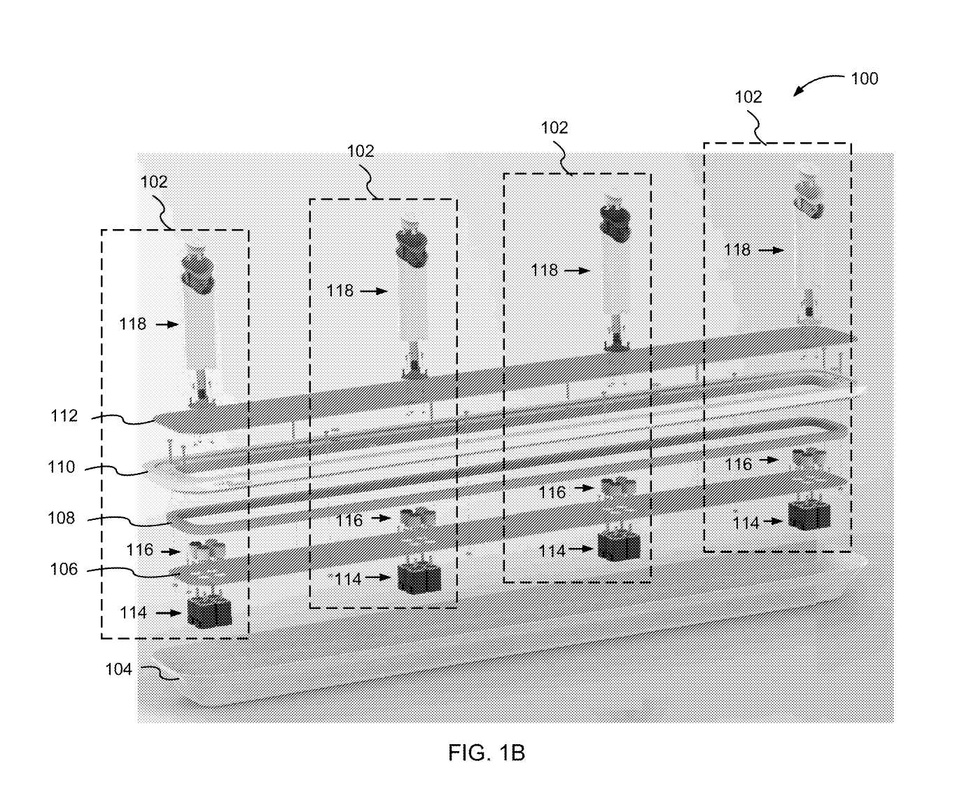

FIG. 1A is an isometric view of a scent dispensing device 100 according to one illustrated embodiment. FIG. 1B is an exploded view of the scent dispensing device 100. The scent dispensing device 100 includes four scent dispensing units 102, a base 104, a lower shelf 106, a spacer 108, a retaining member 110, and an upper shelf 112. Each scent dispensing unit 102 includes four motors 114, four scent cartridges 116, a scent emitter 118, and a number of electronic components that will be described below.

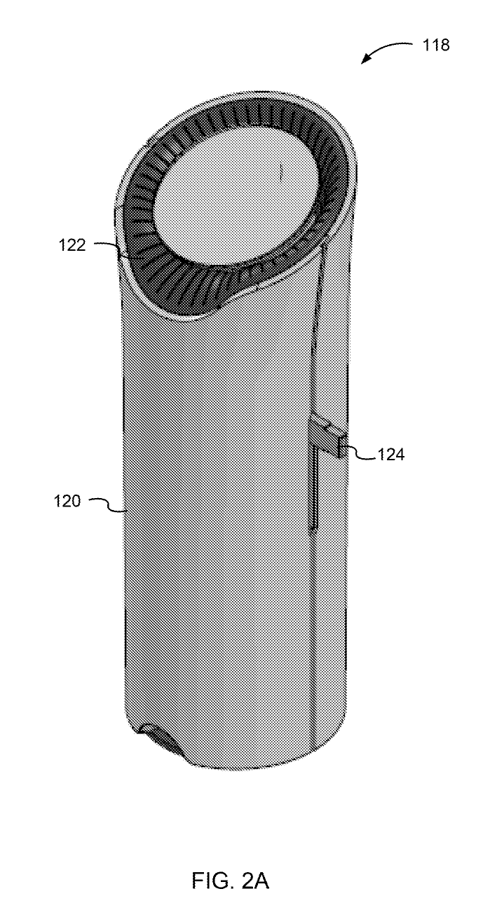

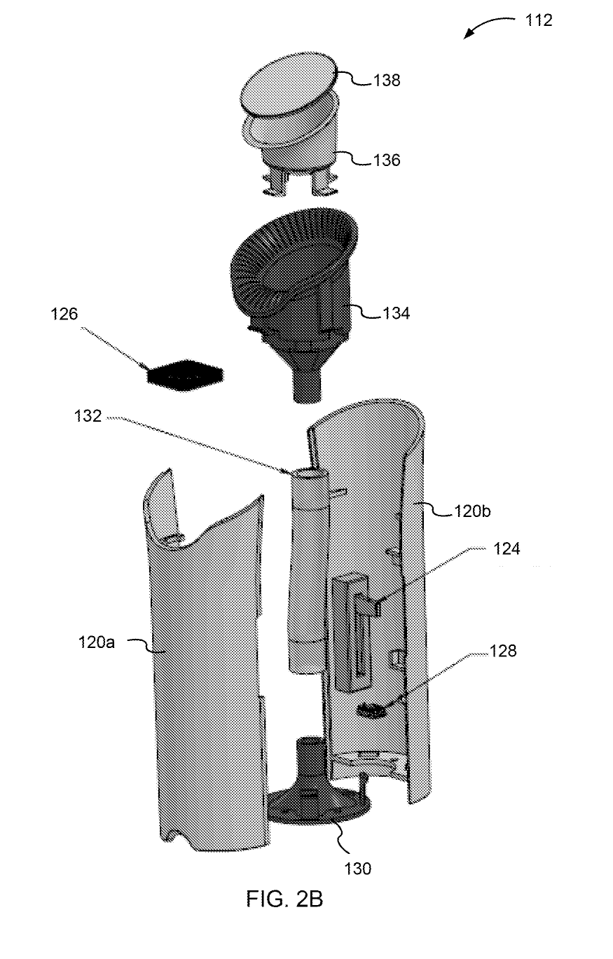

FIG. 2A is an isometric view of the scent emitter 118 according to one illustrated embodiment. FIG. 2B is an exploded view of the scent emitter 118 shown in FIG. 2A. The scent emitter 118 includes a housing 120 having a first housing portion 120a and a second housing portion 120b, a diffuser 122, a switch 124 that is used to control operation of a fan 126, a communications interface connector 128, a scent mixing chamber 130, and a conduit 132. In one embodiment, the communications interface connector 128 is a USB A-Type, female connector. The diffuser 122 includes a first diffuser portion 134, a second diffuser portion 136, and a third diffuser portion 138.

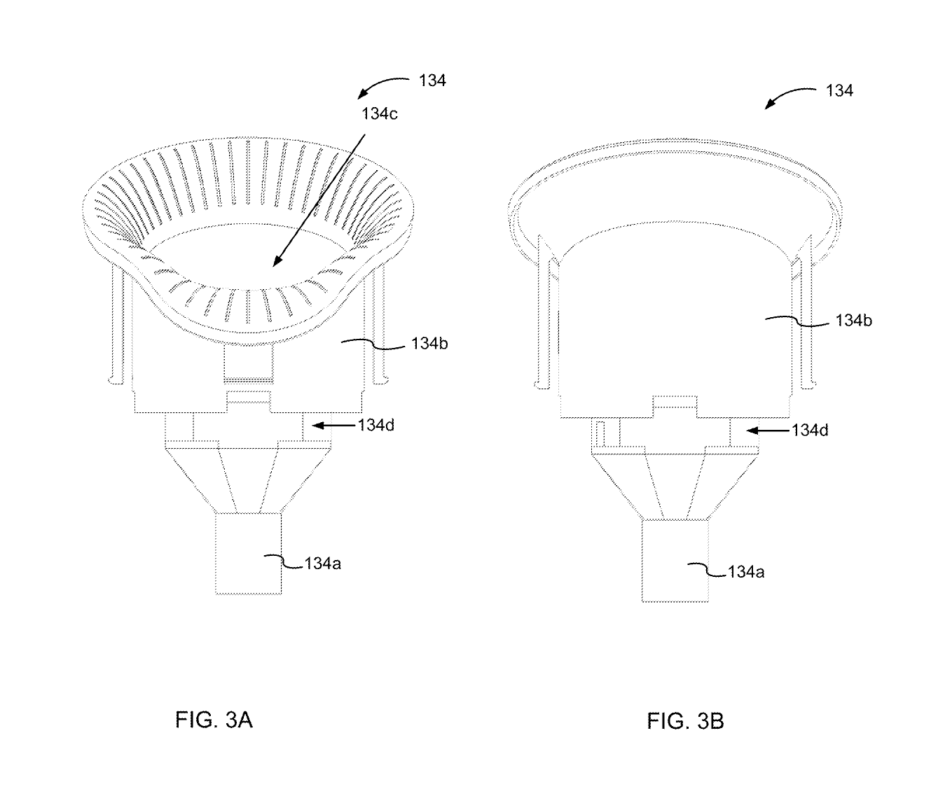

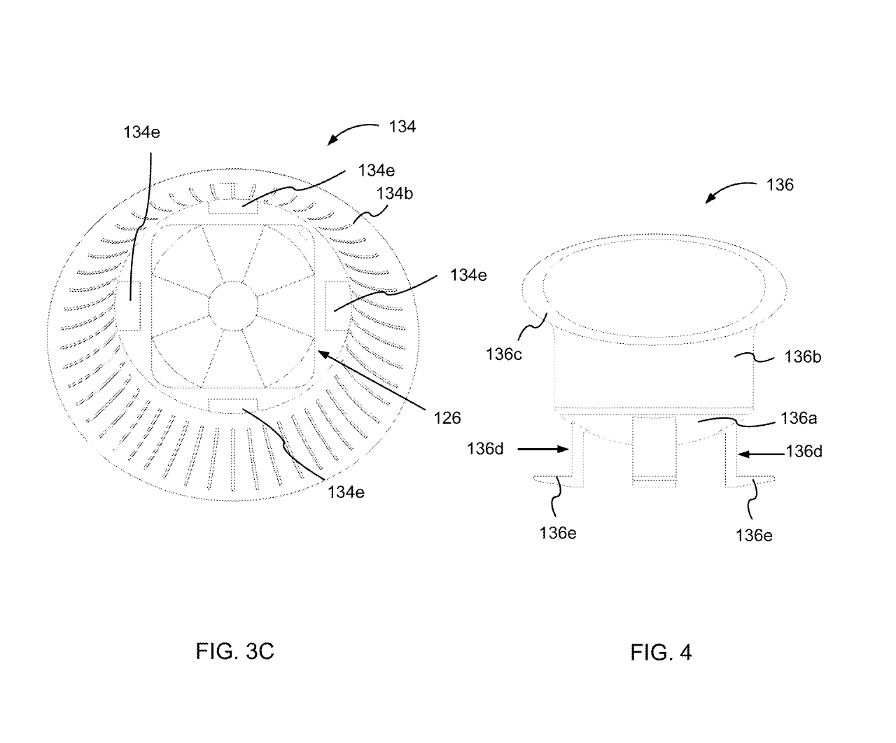

FIGS. 3A-3C show various views of the first diffuser portion 134 shown in FIG. 2B. The first diffuser portion 134 includes an inlet port 134a and a chamber 134b that defines an outlet port 134c. The inlet port 134a of the first diffuser portion 134 serves as an inlet port of the diffuser 122 and the outlet port 134c serves as an outlet port of the diffuser 122. A compartment 134d is disposed between the inlet port 134a and the outlet port 134c. The compartment 134d is sized and dimensioned to hold at least part of the fan 126 therein. The fan 126 is operable to cause air to flow from the inlet port 134a to the outlet port 134c of the first diffuser portion 134. As shown in FIG. 3C, the first diffuser portion 134 includes four rectangular apertures 134e formed in a lower portion of the chamber 134b.

FIG. 4 is a front elevational view of the second diffuser portion 136 shown in FIG. 2B. The second diffuser portion 136 includes a lower portion 136a, an upper portion 136b, and a lip 136c that extends outwardly from the periphery of the top of the upper portion 136b. Four retaining members 136d extend outwardly from the lower portion 136a of the second diffuser portion 136d; only three of the retaining members 136d can be seen in FIG. 4. A tapered portion 136e extends outwardly from each of the retaining members 136d.

The diffuser 122 is assembled by attaching the first diffuser portion 134 to the second diffuser portion 136, and by attaching the third diffuser portion 138 to the second diffuser portion 136. More particularly, the second diffuser portion 136 is placed inside the first diffuser portion 134, the retaining members 136d are aligned with the rectangular apertures 134e formed in a lower portion of the chamber 134b, and the second diffuser portion 136 is advanced toward the first diffuser portion 134 until the tapered portions 136e extend through the rectangular apertures 134e. The third diffuser portion 138 may be attached to the lip 136c of the second diffuser portion 136 using an adhesive. For example, an epoxy resin is placed on the top surface of the lip 136c, the third diffuser portion 138 is placed above the second diffuser portion 136, and the third diffuser portion 138 is advanced toward the second diffuser portion 136 until the bottom surface of the third diffuser portion 138 contacts the epoxy resin on the top surface of the lip 136c.

The first diffuser portion 134 and the second diffuser portion 136 are sized and dimensioned such that, when the second diffuser portion 136 is attached to the first diffuser portion 134, a passage is formed between the interior surfaces of the chamber 134b of the first diffuser portion 134 and the exterior surfaces of the second diffuser portion 136. When the scent emitter 118 is assembled and operated, the fan 126 causes air to flow into the inlet port 134a of the first diffuser portion 134, around the exterior surfaces of the second diffuser portion 136, and out of the outlet port 134c of the first diffuser portion 134.

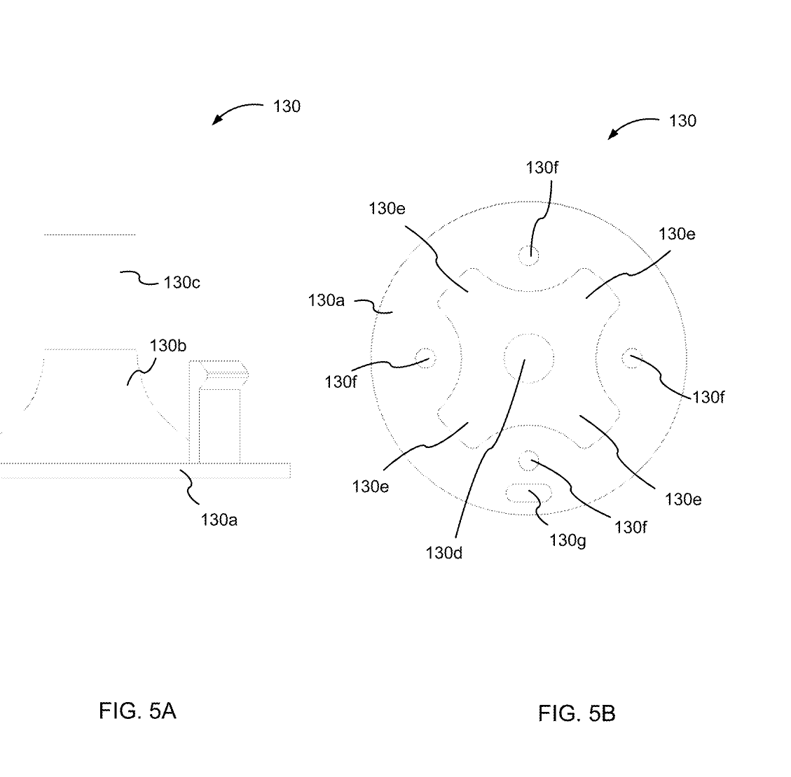

FIGS. 5A and 5B are front and bottom plan views, respectively, of the scent mixing chamber 130. The scent mixing chamber 130 includes a bottom portion 130a, a center portion 130b, and a top portion 130c that serves as an outlet port for the scent mixing chamber 130. As shown in FIG. 5B, the scent mixing chamber 130 includes a plurality of channels 130e that extend from the bottom portion 130a through the center portion 130b to the top portion 130c. The bottom portion 130a of the scent mixing chamber 130 includes four circular apertures 130f and an oval-shaped aperture 130g.

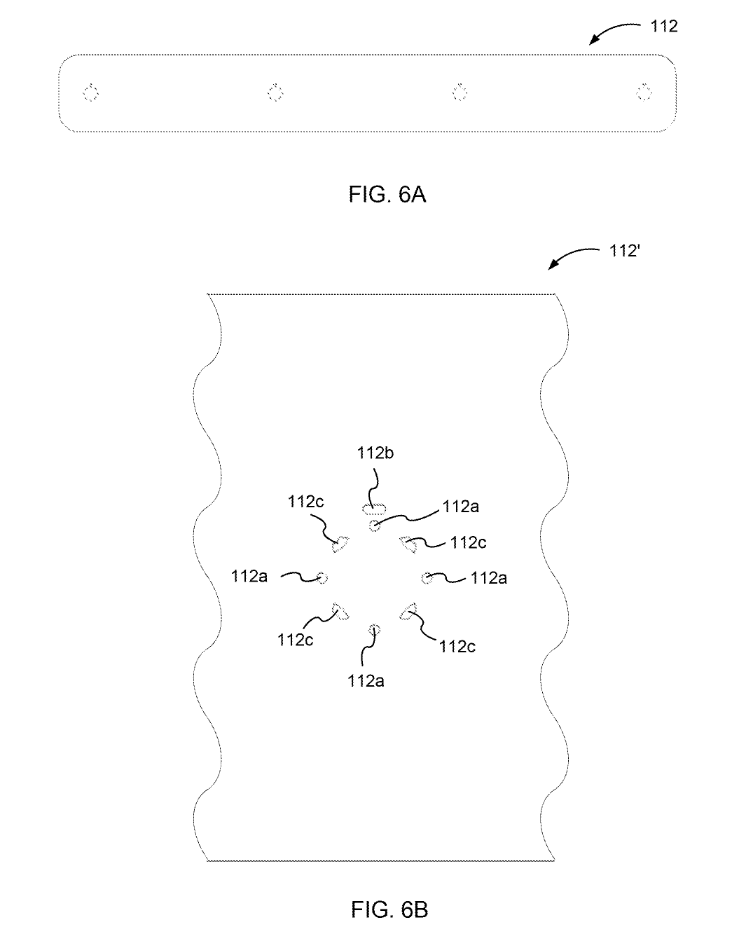

FIG. 6A is a top plan view of the upper shelf 112 of the scent dispensing device 100. FIG. 6B is an enlarged view of a portion 112′ of the upper shelf 112 of the scent dispensing device 100. The portion 112′ of the upper shelf 112 includes four circular apertures 112a, an oval-shaped aperture 112b, and four wedge-shaped apertures 112c.

Four scent mixing chambers 130 are attached to the upper shelf 112 using a plurality of nuts and bolts (not labeled). A process for attaching one of the scent mixing chambers 130 to the upper shelf 112 will now be described with reference to FIGS. 1B, 5A, 5B, 6A, and 6B. The scent mixing chamber 130 is placed on a top surface of the upper shelf 112 such that the circular apertures 130f of the scent mixing chamber 130 are aligned with a group of four circular apertures 112a of the upper shelf 112. Four bolts are inserted into respective circular apertures 130f of the scent mixing chamber 130 and passed through corresponding circular apertures 112a of the upper shelf 112. A nut is then secured to each bolt. The above-described process is repeated for each of the remaining scent mixing chambers 130. When the scent mixing chambers 130 are attached to the upper shelf 112, the wedge-shaped apertures 112c of the upper shelf 112 act as inlet ports to the scent mixing chambers 130.

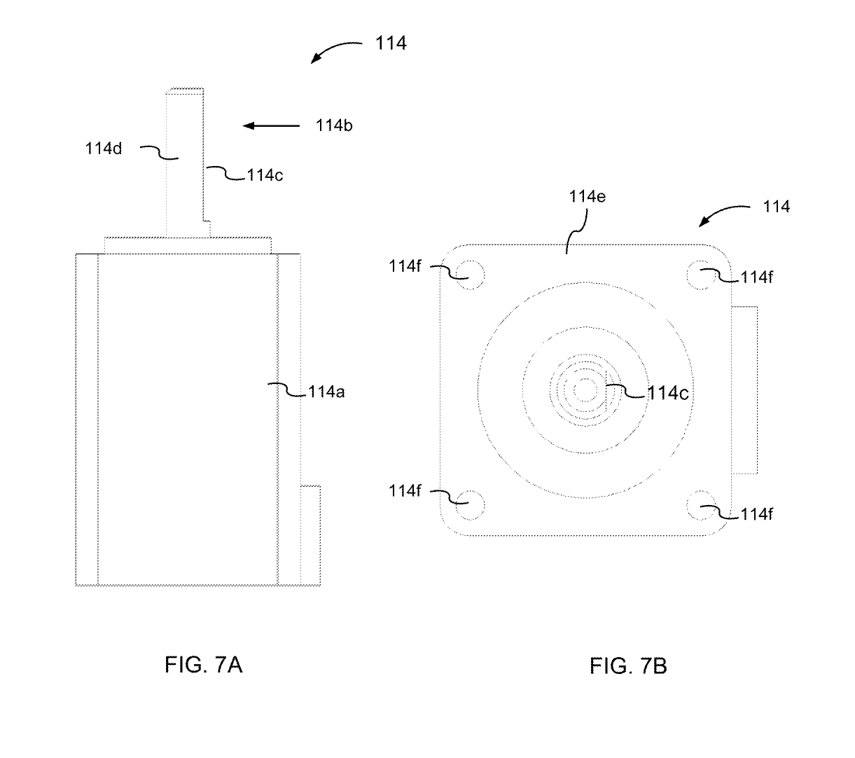

FIG. 7A is a side elevational view of the motor 114 according to one illustrated embodiment. The motor 114 includes a motor housing 114a and a shaft 114b that extends from the motor housing 114a. The shaft 114b includes a flat portion 114c and a truncated cylindrical portion 114d. As shown in FIG. 7B, the motor 114 includes a top portion 114e having a plurality of apertures 114f.

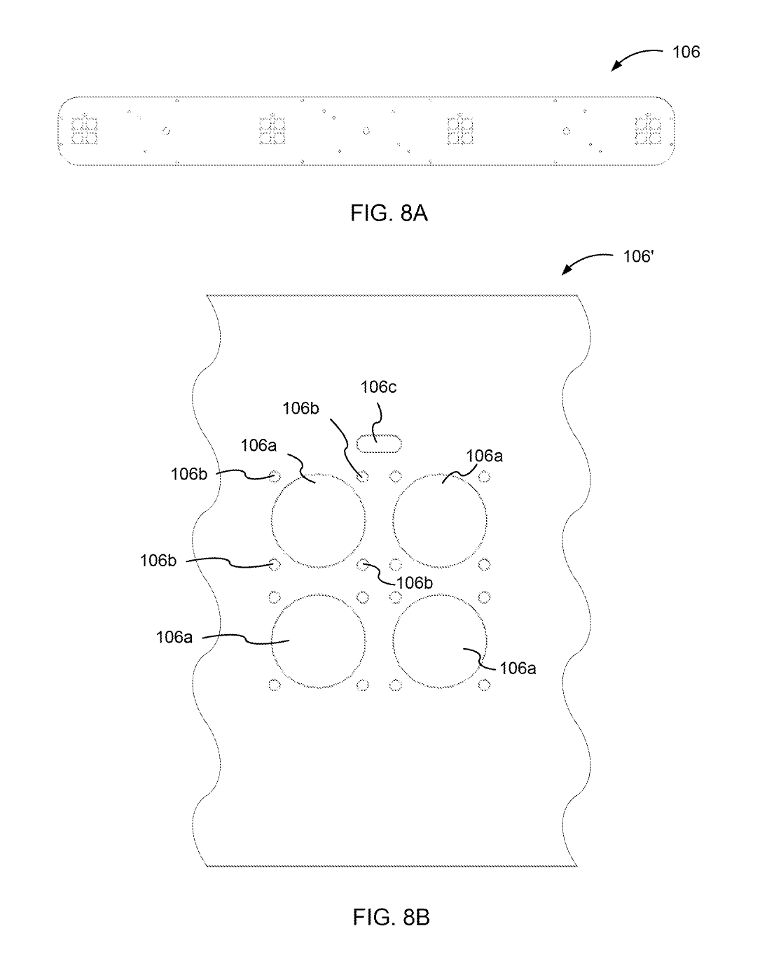

FIG. 8A is a top plan view of the lower shelf 106 of the scent dispensing device 100. FIG. 8B is an enlarged view of a portion 106′ of the upper shelf 106 shown in FIG. 8A. The portion 106′ of the lower shelf 106 includes four large circular apertures 106a, sixteen small circular apertures 106b, and an oval-shaped aperture 106c.

Sixteen motors 114 are attached to the lower shelf 106 using a plurality of bolts (not labeled). A process for attaching one of the motors 114 to the lower shelf 106 will now be described with reference to FIGS. 1B, 7A, 7B, 8A, and 8B. One of the motors 114 is placed below the lower shelf 106 such that the circular apertures 114f of the motor 114 are aligned with a group of four small circular apertures 106b surrounding one of the large circular apertures 106a of the lower shelf 106. The motor 114 is advanced toward the lower shelf 106 and the shaft 114b is passed through the large circular aperture 106a until the top portion 114e of the motor 114 abuts the bottom surface of the lower shelf 106. Four bolts are inserted through respective small circular apertures 106b of the lower shelf 106 and are advanced into the circular apertures 114f of the motor 114. The bolts are rotated to engage threads (not shown) within the motor housing 114a thereby attaching the motor 114 to the lower shelf 106. The above-described process is repeated for the remaining fifteen motors 114.

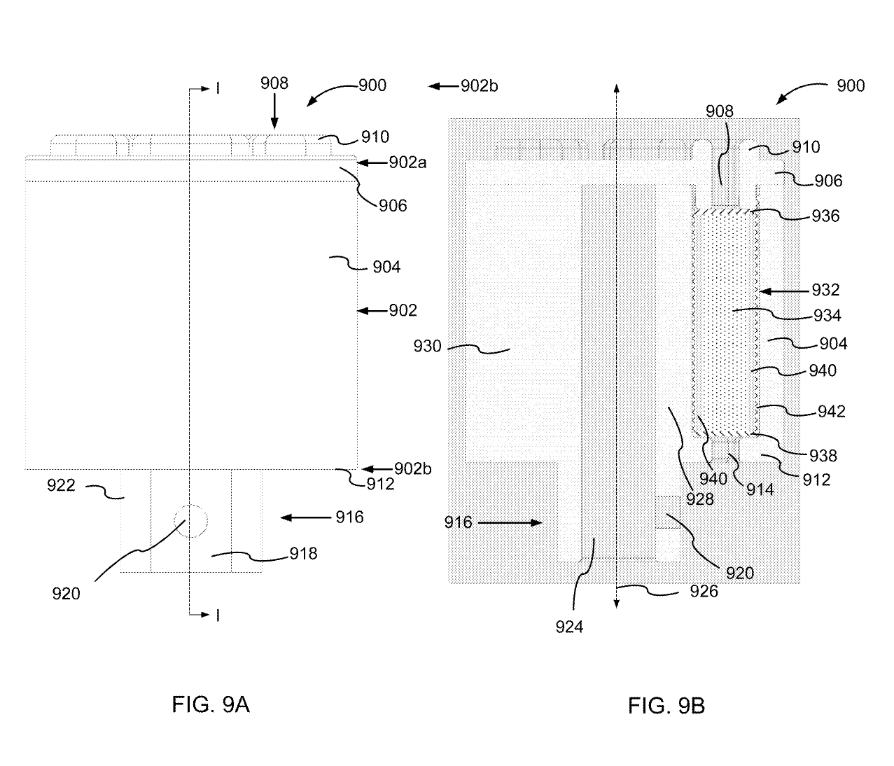

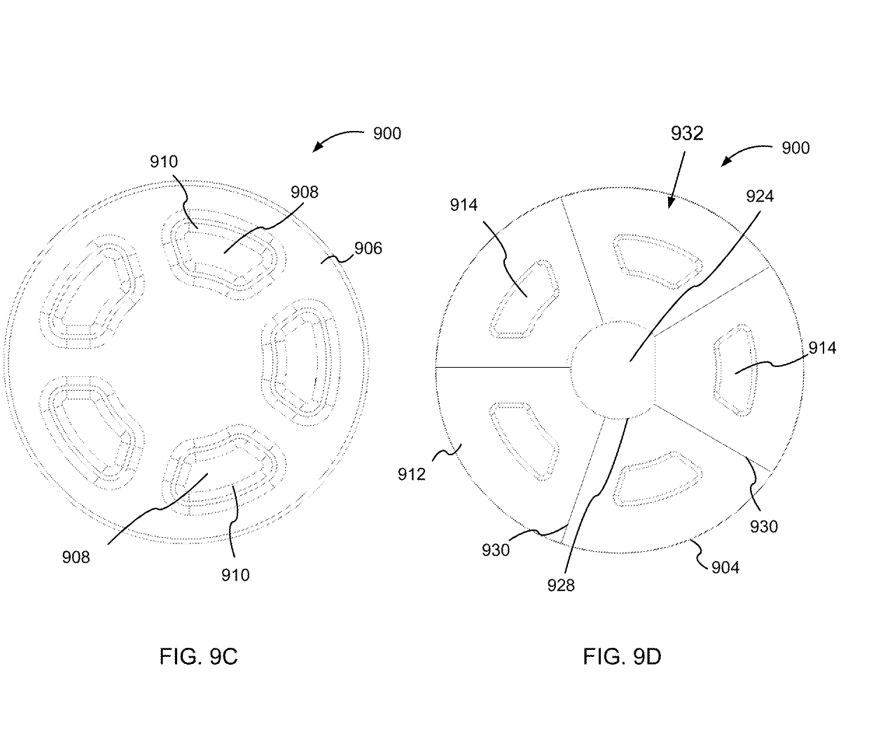

A scent cartridge 900 according to one illustrated embodiment will now be described with reference to FIGS. 9A-9D. FIG. 9A is a front elevational view of the scent cartridge 900. FIG. 9B is cross-sectional view taken along line I-I of FIG. 9A. FIG. 9C is a top plan view the scent cartridge 900. FIG. 9D is top plan view of the scent cartridge of FIG. 900, with a first end portion 906 removed.

As shown in FIG. 9A, the scent cartridge 900 includes a housing 902 having a first end 902a and a second end 902b. A cylindrical outer wall 904 defines a peripheral perimeter of the housing 902. A first end portion 906 is disposed at the first end 902a of the scent cartridge 900. The first end portion 906 includes five wedge-shaped apertures 908. A raised lip 910 extends outwardly from the first end portion 906 around the periphery of each of the apertures 908.

A second end portion 912 is disposed at the second end 902b of the scent cartridge 900. As best shown in FIG. 9D, the second end portion 912 includes five wedge-shaped apertures 914. As best shown in FIG. 9A, an axle 916 extends outwardly from the second end portion 912. The axle 916 includes a planar portion 918 having a circular aperture 920. The axle 916 also includes a truncated cylindrical portion 922. The planar portion 918 and the truncated cylindrical portion 922 form a “D” shaped aperture 924. The aperture 924 of the axle 916 is sized and dimensioned such that the shaft 114b of the motors 114 can be inserted into the aperture 924. When the shaft 114b of one of the motors 114 is inserted into the aperture 924 of the axle 916, the planar portion 114c of the shaft 114b is adjacent the planar portion 918 of the axle 916, which ensures that rotation of the shaft 114d causes rotation of the scent cartridge 900 about a longitudinal axis 926 of the scent cartridge 900.

FIG. 9C is a top view of the scent cartridge 900, and FIG. 9D is a top view of the scent cartridge 900 with the first end portion 906 removed. A plurality of walls extends upwardly from the second end portion 912, including the outer wall 904, an axial wall 928, and five planar walls 930. The planar walls 930 extend radially from the axial wall 928 to the outer wall 904. The first end portion 906, the second end portion 912, the planar walls 930, the axial wall 928, and the outer wall 904 define five chambers 932 within the scent cartridge 900. For each of the chambers 932, one of the apertures 908 formed in the first end portion 906 is aligned with a corresponding aperture 914 formed in the second end portion 912.

Referring now to FIG. 9B, a cross-sectional view of the scent cartridge 900 taken along line I-I of FIG. 9A is shown. Only one of the five chambers 932 can be seen in FIG. 9B. The scent cartridge 900 may have virtually any desired number of scent cartridge chambers 932. One or more of the chambers 932 may be filled with a scent medium 934. The scent medium 934 may be a non-liquid substance such as aromatic particles, a scented powder, which may be in a packed powder form, a scented wax, an air filter, or an unscented material. One or more of the chambers 932 may be empty.

A first selective membrane 936 may be attached to the bottom surface of the first end portion 906 of the scent cartridge 900. The first selective membrane 936 includes apertures (not shown) formed therein that are sized and dimensioned to enable the molecules of the scent medium 934 to flow from the apertures 908 of the first end portion 906 of the scent cartridge 900. For example, the scent medium 934 may be in a particulate form and the first selective membrane 936 selectively passes air or scented air while not passing the scent medium 934 in the particulate form. In one embodiment, the scent cartridge 900 does not include the first selective membrane 936.

A second selective membrane 938 may be attached to the upper surface of the second end portion 912. The second selective membrane 938 may include apertures (not shown) formed therein that are sized and dimensioned to prevent the scent medium 934 from falling out of the apertures 914, and to enable air to flow through the apertures 914. In one embodiment, the second selective membrane 938 is a non-porous plastic material. In another embodiment, the scent cartridge 900 does not include the second selective membrane 938. In one embodiment, the first selective membrane 936 and the second selective membrane 938 are formed from a cotton material having a thread count of 56 threads per centimeter.

As shown in FIG. 9B, the scent medium 934 may be positioned in the chamber 932 such that one or more gaps 940 are formed along the length of the housing 902 between one or more of the walls that define the chamber 932 and the scent medium 934. In FIG. 9B, one of the gaps 940 is formed between the scent medium 934 and the outer wall 904, and one of the gaps is formed between the scent medium 934 and the axial wall 928. The gaps 940 facilitate air flow through the chamber 932.

In one embodiment, one or more interior surfaces of one or more of the walls that define one or more of the scent cartridge chambers 932 have a coating 942 (e.g., wax) formed thereon. In FIG. 9B, the coating 942 is formed on the interior surfaces of the outer wall 904 and the axial wall 928.

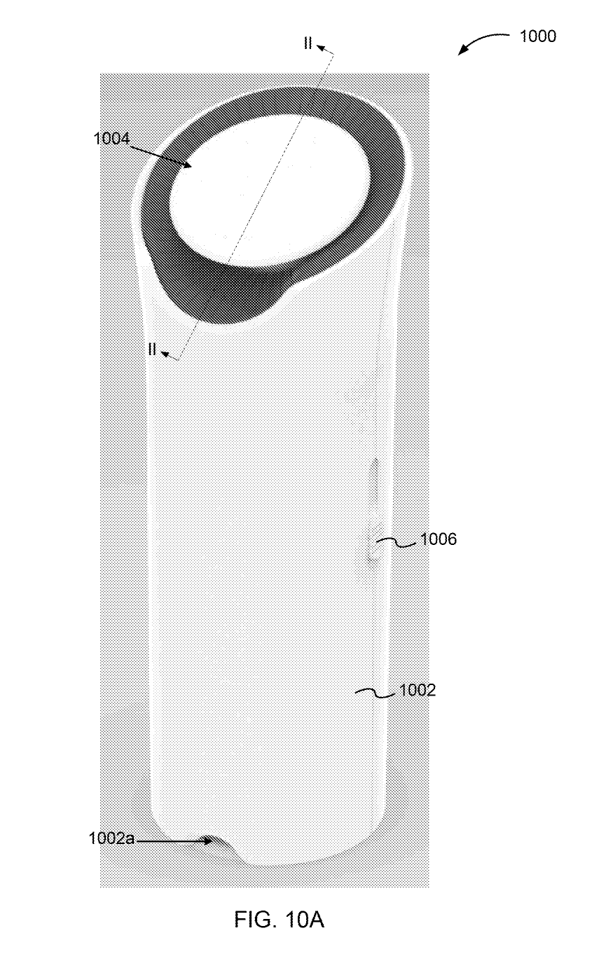

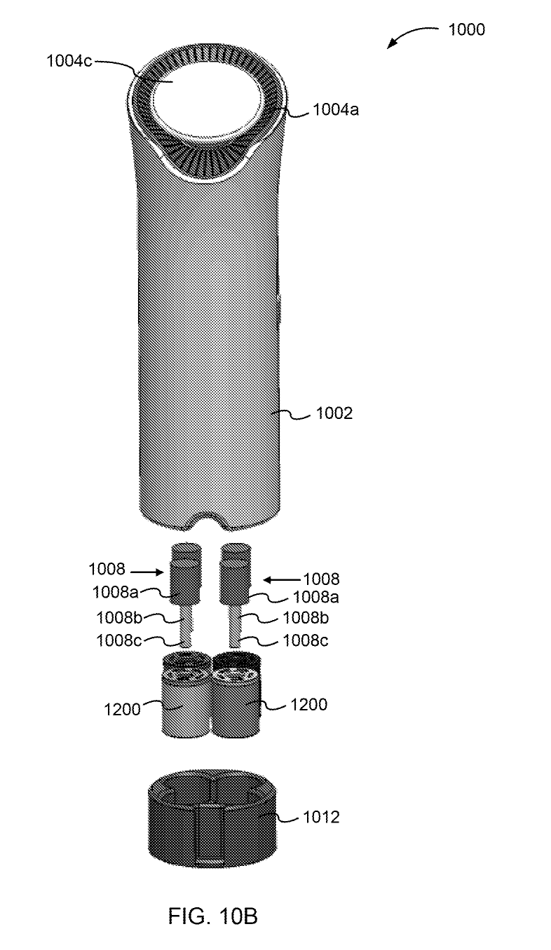

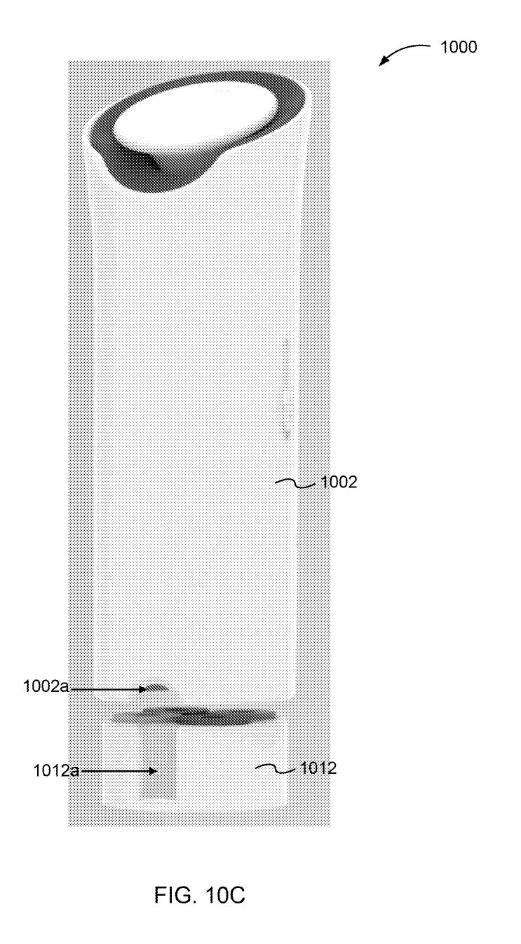

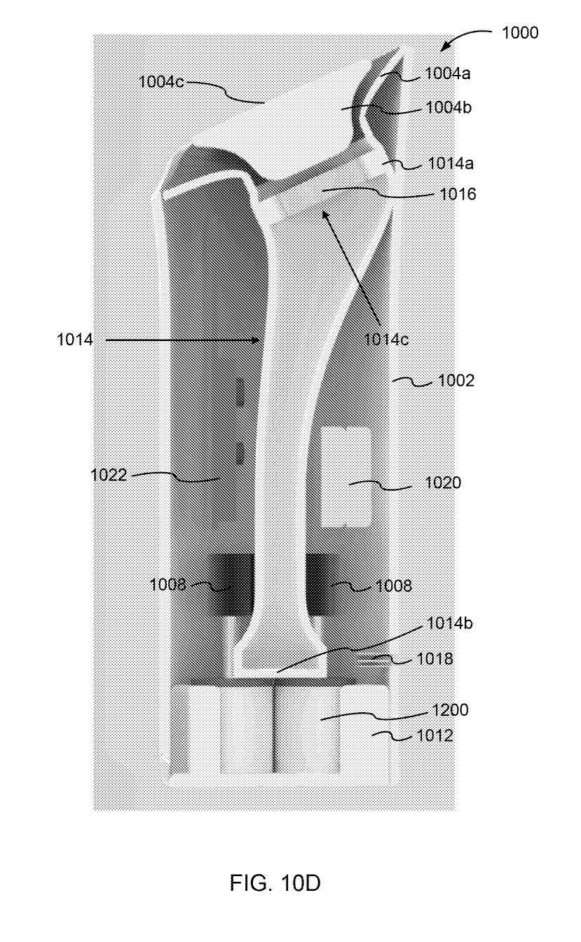

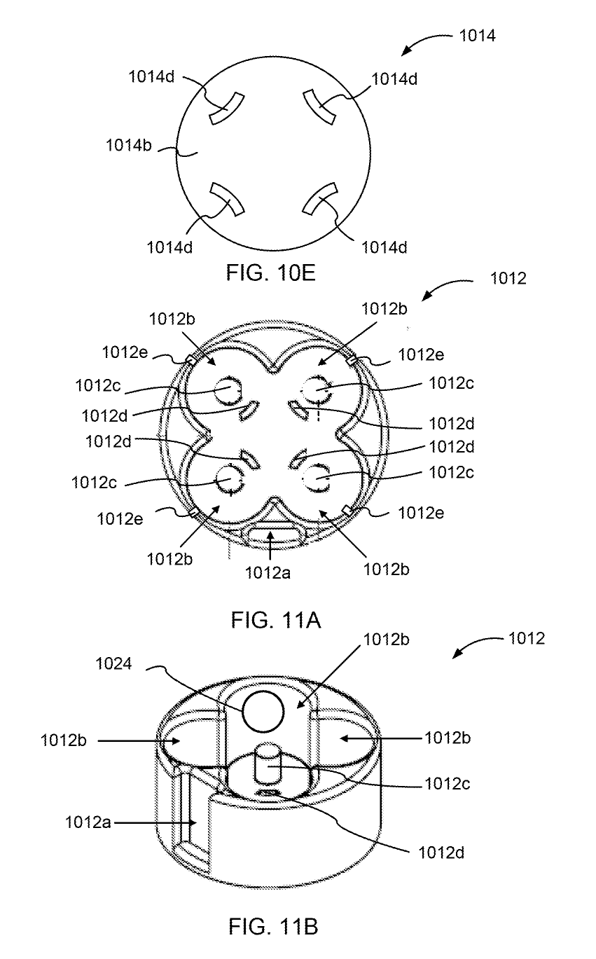

A scent dispensing device 1000 according to one illustrated embodiment will now be described with reference to FIGS. 10A-10E. FIG. 10A is an isometric view of the scent dispensing device 1000. FIGS. 10B and 10C are partially exploded views of the scent dispensing device 1000. FIG. 10D is cross-sectional view taken along line II-II of FIG. 10A. FIG. 10E is a bottom plan view of a scent mixing chamber shown in FIG. 10D.

As shown in FIG. 10A, the scent dispensing device 1000 includes a housing 1002 having a recessed portion 1002a, a diffuser 1004, and a switch 1006. As shown in FIG. 10B, the scent dispensing device 1000 also includes four motors 1008, four scent cartridges 1200, and a scent cartridge holder 1012. Each of the motors 1008 includes a housing 1008a, a shaft 1008b, and an end portion 1008c. In one embodiment, each of the motors 1008 is a stepper motor. As shown in FIG. 10C, the scent cartridge holder 1012 has a recessed portion 1012a that can be aligned with the recessed portion 1002a of the housing 1002. The recessed portions 1002a and 1012a facilitate removal of the scent cartridge holder 1012 from the housing 1002 so that cartridges 1200 can be loaded into and/or unloaded from the scent cartridge holder 1012. The recessed portions 1002a and 1010a also serve as alignment structures that ensure that the scent cartridge holder 1012 has a predetermined orientation relative to the housing 1002 when the scent cartridge holder 1012 is disposed within the housing 1002.

As shown in FIG. 10D, the diffuser 1004 includes a first diffuser portion 1004a, a second diffuser portion 1004b, and a third diffuser portion 1004c. The first diffuser portion 1004a, the diffuser second portion 1004b, and the third diffuser portion 1004c are similar to the first diffuser portion 134, the second diffuser portion 136, and the third diffuser portion 138, respectively. The scent dispensing device 1000 includes a scent mixing chamber 1014 that includes an upper portion 1014a and a lower portion 1014b. The upper portion 1014a of the scent mixing chamber 1014 includes an aperture 1014c that serves as an outlet port for the scent mixing chamber 1014. A fan 1016 is disposed in the aperture 1014c of the scent mixing chamber 1014. The scent dispensing device 1000 also includes an interface connector 1018, one or more batteries 1020, and a printed circuit board 1022. In one embodiment, the communications interface connector 1018 is a USB A-Type, female connector. The printed circuit board 1022 includes various components and circuits for communicating and processing scent information, and for controlling operation of the motors 1008 and the fan 1016 based on such scent information.

As shown in FIG. 10E, the lower portion 1014b of the scent mixing chamber 1014 includes four wedge-shaped apertures 1014d. Each of the wedge-shaped apertures 1014d serves as an inlet port to the scent mixing chamber 1014. FIG. 11A is a top plan view of the scent cartridge holder 1012 shown in FIG. 10B. FIG. 11B is an isometric view of the scent cartridge holder 1012. The scent cartridge holder 1012 includes four scent cartridge receptacles 1012b, each of which is sized and dimensioned to receive at least a lower portion of one of the scent cartridges 1200. Each scent cartridge receptacle 1012b includes a shaft or axle 1012c, a wedge-shaped aperture 1012d, and an alignment indicator 1012e. The alignment indicator 1012e may take a variety of forms, for example, a marking, an indentation, or a projection.

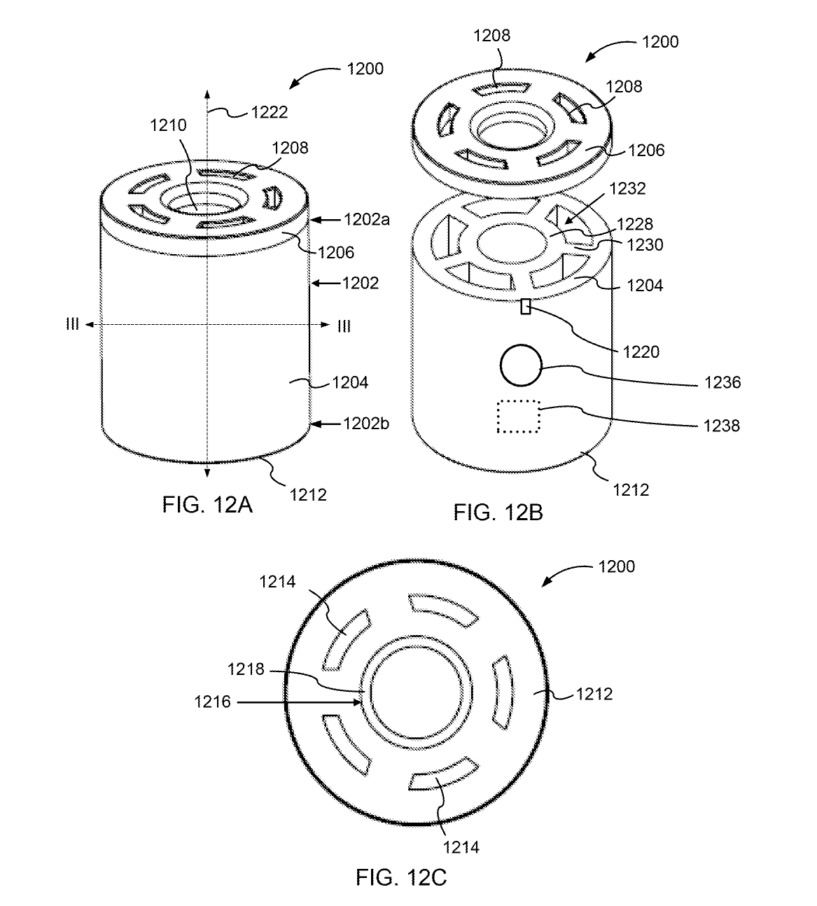

The scent cartridge 1200 according to one illustrated embodiment will now be described with reference to FIGS. 12A-12C. FIG. 12A is an isometric view of the scent cartridge 1200. FIG. 12B is a partially exploded view of the scent cartridge 1200. FIG. 12C is a bottom plan view of the scent cartridge 1200. As shown in FIG. 12A, the scent cartridge 1200 includes a housing 1202 having a circular peripheral perimeter. The housing 1202 includes a first end 1202a and a second end 1202b. A cylindrical outer wall 1204 defines a peripheral perimeter of the housing 1202.

A first end portion 1206 is disposed at the first end 1202a of the housing 1202. The first end portion 1206 includes five wedge-shaped apertures 1208 and an aperture 1210. The aperture 1210 and the end portion 1008c of the shaft 1008b of each of the motors 1008 are sized and dimensioned such that the end portion 1008c can be inserted into the aperture 1210. In one embodiment, the end portion 1008c and the aperture 1210 are circular and the end portion 1008c can be inserted snugly into the aperture 1210 such that rotation of the shaft 1008b causes rotation of the scent cartridge 1200 about a longitudinal, rotational axis 1222. In one embodiment, the end portion 1008c and the aperture 1210 are “D” shaped and the end portion 1008c of the shaft 1008b of each motor 1008 can be inserted into the aperture 1210 such that rotation of the shaft 1008b causes rotation of the scent cartridge 1200 about the longitudinal axis 1222.

A second end portion 1212 is disposed at the second end 1202b of the housing 1202. The second end portion 1212 includes five wedge-shaped apertures 1214. A circular aperture 1216 is formed in the second end portion 1212 and extends upwardly into the housing 1202 and ends a bearing surface 1218. The circular aperture 1216 and the axles 1012c of the scent cartridge holder 1012 are sized and dimensioned such that each axle 1012c can be inserted into the circular aperture 1216 such that the scent cartridge 1200 is able to rotate about the longitudinal axis 1222 when the axle 1012c is inserted into the circular aperture 1216. An annular bearing surface 1018 is included at the second end 1202b of the housing 1200 adjacent the circular aperture 1216. The annular bearing surface 1018 is disposed about the axis of rotation 1222 such that, when the axle 1012c of the scent cartridge holder 1012 is inserted into the circular aperture 1216 and the scent cartridge 1200 is rotated, the annular bearing surface 1018 abuts the side surfaces of the axle 1012c.

As shown in FIG. 12B, a plurality of walls extends upwardly from the second end portion 1212, including the outer wall 1204, an axial wall 1228, and five planar walls 1230. The planar walls 1230 extend radially from the axial wall 1228 to the outer wall 1204. The outer wall 1204, the first end portion 1206, the second end portion 1212, the axial wall 1228, and the planar walls 1230 define five chambers 1232 within the scent cartridge 1200 that are annularly arrayed about the rotational axis 1222. For each of the chambers 1232, one of the apertures 1208 formed in the first end portion 1206 is aligned with a corresponding aperture 1214 formed in the second end portion 1212. Each chamber 1232 defines a channel in which air can be fluidly communicated from the aperture 1214 formed in the second end portion 1212 to the corresponding aperture 1208 formed in the first end portion 1206. The outer wall 1204, the axial wall 1228, and the planar walls 1230 prevent air flowing through one of the chambers 1232 from leaking into any other of the chambers 1232.

As will be explained in detail below, the end portion 1008c of the shaft 1008b of the motors 1008 can engage the aperture 1216 of the scent cartridge 1200 and cause it to rotate into one of five predetermined positions/orientations in which a particular one of the wedge-shaped apertures 1208 of the first end portion 1206 of the scent cartridge 1200 is aligned with one of the wedge-shaped apertures 1014d of the lower portion 1014b of the scent mixing chamber 1014. When the scent cartridge 1200 is in such a position, the corresponding wedge-shaped aperture 1214 of the second end portion 1212 of the scent cartridge 1200 is aligned with one of the wedge-shaped apertures 1012d of the scent cartridge holder 1012. In one embodiment, the size and dimensions of the wedge-shaped apertures 1012d, 1014c, 1208, and 1214 are the same. When the scent cartridge 1200 is in such a position/orientation, the fan 1016 can cause air to flow into one of the wedge-shaped apertures 1012d of the scent cartridge holder 1012, through one of the chambers 1232 via corresponding wedge-shaped apertures 1214 and 1208, through the scent mixing chamber 1014 via apertures 1014d and 1014c, and out of the diffuser 1004.

The scent cartridge 1200 also includes an alignment indicator 1220. The alignment indicator 1220 may take a variety of forms, for example, a marking, an indentation, or a projection. When the alignment indicator 1220 of one of the scent cartridges 1200 is aligned with one of the alignment indicators 1012e of the scent cartridge holder 1012, an aperture 1214 of a predetermined one of the chambers 1232 (i.e., a default chamber) is aligned with one of the apertures 1012d formed in the scent cartridge holder 1012. A user of the scent dispensing device 1000 may align the alignment indicator 1220 of one of the scent cartridges 1200 with one of the alignment indicators 1012e of the scent cartridge holder 1012 when the scent cartridge 1200 is initially installed in the scent cartridge holder 1012. When the alignment indicator 1220 of one of the scent cartridges 1200 is aligned with one of the alignment indicators 1012e of the scent cartridge holder 1012, and the scent cartridge holder 1012 is inserted into the housing 1002 of the scent dispensing device 1000, an aperture 1208 of the first end portion 1206 of the default chamber 1232 of the scent cartridge 1200 is aligned with one of the apertures 1014d of the lower portion 1014b of the scent mixing chamber 1014.

Although the scent cartridge 1200 is described in connection with the scent dispensing device 1000, the scent cartridge 1200 may be used in other scent dispensing devices. For example, the scent cartridge 1200 may be used in other scent dispensing devices that are included with printers, cameras, clothing, chairs, kitchen appliances, and automobiles. Such scent dispensing devices may enable a user to specify a particular scent or scent combination by manually rotating one or more of the scent cartridges 1200 such that a particular chamber 1232 of each of the scent cartridges 1200 has a predetermined orientation. Alternatively, the scent dispensing device 1000 may be integrated with other devices, such as printers, cameras, clothing, chairs, kitchen appliances, and automobiles.

The scent cartridge holder 1012 of the scent dispensing device 1000 described above includes four scent cartridge receptacles 1012b, and each of the scent cartridges 1200 described above includes five chambers 1232. If four of the chambers 1232 of each of the scent cartridges 1200 include a scent medium 1234 (e.g., one of the chambers 1232 of each of the scent cartridges 1200 is empty) and the scent of each scent medium 1234 is different than that of every other scent medium 1234, the scent dispensing device 1000 could dispense 340 different scent combinations (i.e., 4⁴+4³+4²+4¹).

In one embodiment, the scent cartridge holder 1012 of the scent dispensing device 1000 includes five scent cartridge receptacles 1012b, and each of the scent cartridges 1200 includes six chambers 1232. If five of the chambers 1232 of each of the scent cartridges 1200 include a scent medium 1234 (e.g., one of the chambers 1232 of each of the scent cartridges 1200 includes an air filter) and the scent of each scent medium 1234 is different than that of every other scent medium 1234, the scent dispensing device 1000 could dispense 3,905 different scent combinations (i.e., 5⁵+5⁴+5³+5²+5¹).

In another embodiment, the scent cartridge holder 1012 of the scent dispensing device 1000 includes six scent cartridge receptacles 1012b, and each of the scent cartridges 1200 includes seven chambers 1232. If six of the chambers 1232 of each of the scent cartridges 1200 include a scent medium 1234 (e.g., one of the chambers 1232 of each of the scent cartridges 1200 is empty) and the scent of each scent medium 1234 is different than that of every other scent medium 1234, the scent dispensing device 1000 could dispense 55,986 different scent combinations (i.e., 6⁶+6⁵+6⁴+6³+6²+6¹).

Of course, the scent cartridge holder 1012 of the scent dispensing device 1000 may include another number of scent cartridge receptacles 1012b, and each of the scent cartridges 1200 may include another number of chambers 1232. Additionally, the scent media 1234 can be distributed within the chambers 1232 of the scent cartridges 1200 such that the scent dispensing device 1000 could produce virtually any desired number of different scent combinations.

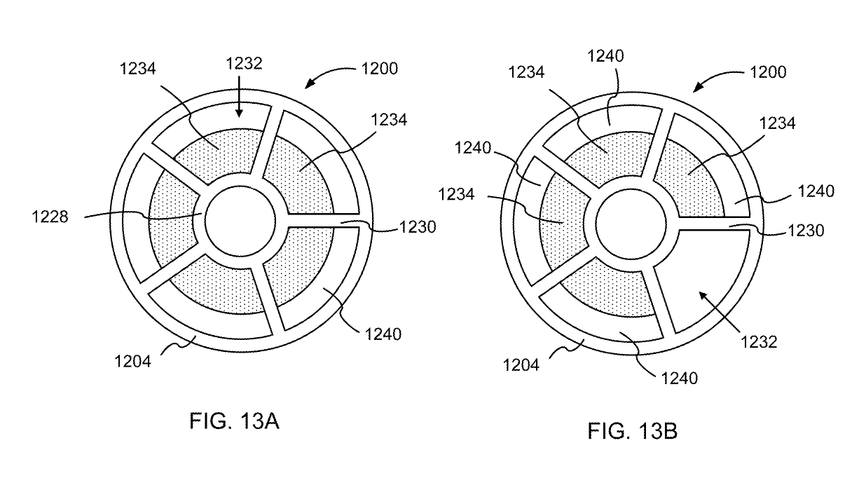

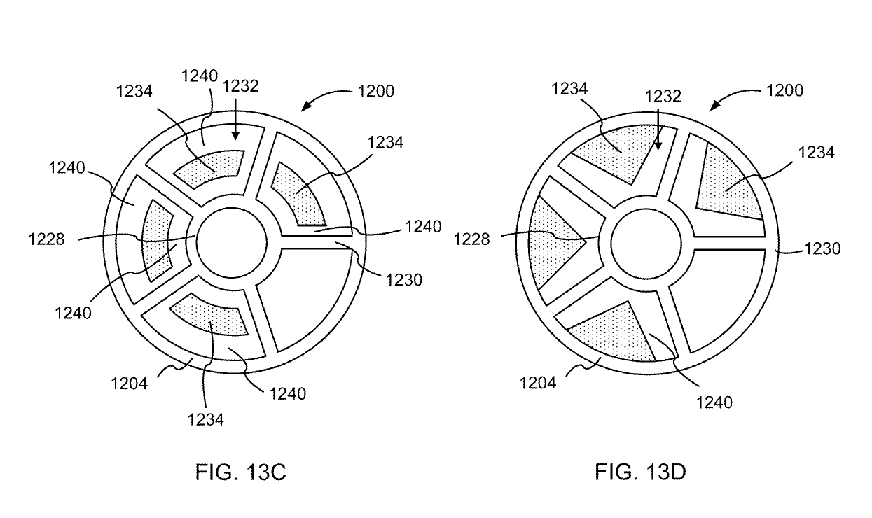

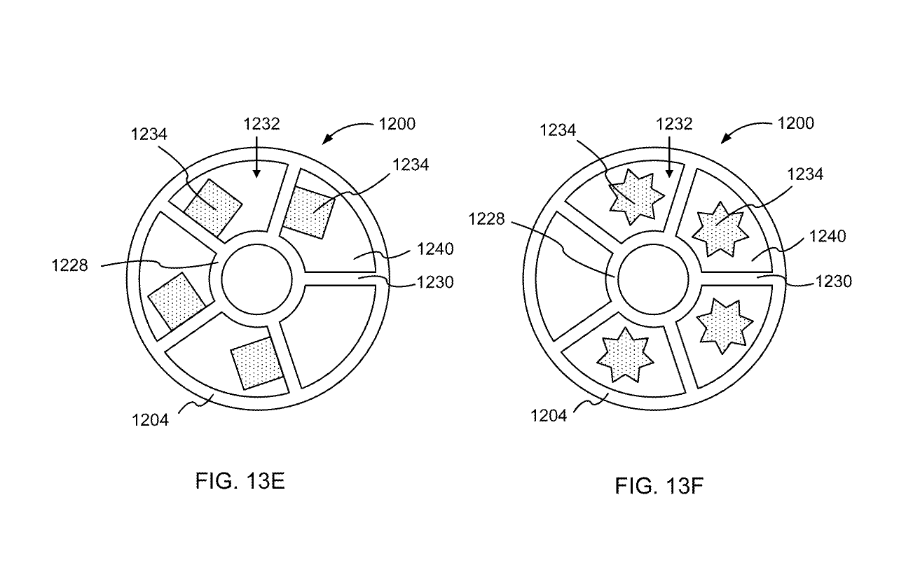

A number of example embodiments of the scent cartridge 1200 will now be described with reference to FIGS. 13A-13F. Each of FIGS. 13A-13F shows a horizontal slice view of the scent cartridge 1200 along the line III-III shown in FIG. 12A. In each of the example embodiments, one or more scent media 1234 are arranged in one or more of the chambers 1232. Each scent medium 1234 is arranged similarly to the scent medium 934 described above in connection with FIG. 9B. For example, each scent medium 1234 may be arranged in one of the chambers 1232 between corresponding ones of the apertures 1208 and 1214 such that a first selective membrane 936 is disposed between the scent medium 1234 and the aperture 1208 and/or a second selective membrane 938 is disposed between the scent medium 1234 and the aperture 1214.

FIG. 13A illustrates an embodiment in which each of the chambers 1232 includes a scent medium 1234. One or more of the scent media 1234 may have a scent or aroma that is the same as or different than that of one or more of the other scent media 1234. For example, each scent medium 1234 may have a scent or aroma that is different than that of the other scent media 1234. One or more of the scent media 1234 may be unscented, for example, an air filter medium (e.g., a medium including a charcoal filter) and/or a scent neutralizing medium (e.g., a medium including baking soda).

As shown in FIG. 13B, one or more of the chambers 1232 may be empty. Additionally, a gap 1240 may be disposed between each of the scent media 1234 and one or more of the walls that define each chamber 1232. For example, within one or more of the chambers 1232, the gap 1240 may be disposed between the scent medium 1234 and the outer wall 1204.

As shown in FIG. 13C, within one or more of the chambers 1232, the gap 1240 may be disposed between the scent medium 1234 and each of the walls that define the one or more chambers 1232. That is, within one or more chambers 1232, the gap 1240 may be disposed between the scent medium 1234 and the outer wall 1204, the axial wall 1228, and a pair of planar walls 1230.

The scent media 1234 may be disposed on one of the walls of one or more of the chambers 1232. For example, each scent medium 1234 may be disposed on the outer wall 1204 as shown in FIG. 13D, or may be disposed on one of the planar walls 1230 as shown in FIG. 13E.

Each scent medium 1234 may be arranged such that greater than fifty percent of the total surface area of the scent medium 1234 is exposed to the air that flows through one of the chambers 1232. For example, the dimensions of each scent medium 1234 shown in FIG. 13E may be as follows: the length is equal to 1 centimeter (cm), the width is equal to 1 cm, and the height is 5 cm. Accordingly, the total surface area of each scent medium 1234 is the surface area of four side portions (i.e., 4×1 cm×5 cm=20 cm²) plus the surface area of two end portions (i.e., 2×1 cm×1 cm=2 cm²) or 22 cm². The surface area of the side portion touching one of the planar walls 1230 is 1 cm×5 cm or 5 cm². Assuming that the apertures 1208 and 1214 of the first and the second end portions 1206 and 1212, respectively, are sized and dimensioned such that one-hundred percent of the surface area of each end portion of the scent media 1234 is exposed to air flowing in each chamber 1232, the surface area of each scent medium 1234 that is exposed to air flowing through one of the chambers 1232 is the surface area of three side portions (i.e., 3×1 cm×5 cm=15 cm²) plus the surface area of two end portions (i.e., 2×1 cm×1 cm=2 cm²) or 17 cm². Accordingly, roughly 72% (i.e., 17 cm²/22 cm²) of each scent medium 1234 is exposed to air flowing through one of the chambers 1232.

FIG. 13F shows an example in which a star-shaped scent medium 1234 is provided in four of the chambers 1232, such that the gap 1240 is provided between the scent media 1234 and inner surfaces of each of the walls that define the chambers 1232. Assuming that the apertures 1208 and 1214 of the first and the second end portions 1206 and 1212, respectively, are sized and dimensioned such that one-hundred percent of the surface area of each end portion of the scent media 1234 is exposed to air flowing in the chambers 1232, one-hundred percent of the surface area of each scent medium 1234 is exposed to air flowing through one of the chambers 1232.

The example cross-sectional shapes and positions of the scent media 1234 shown in FIGS. 13A-13F are illustrative and are not limiting. The cross-sectional shapes of the scent media 1234 may take a variety of shapes including circles, squares, rectangles, triangles, ovals, wedges, stars, etc. Additionally, each scent medium 1234 may be arranged such that the gap 1240 is provided between the scent medium 1234 and an inner surface of at least one wall of the one of the chambers 1232, wherein the gap 1240 extends along the length of the housing 1202.

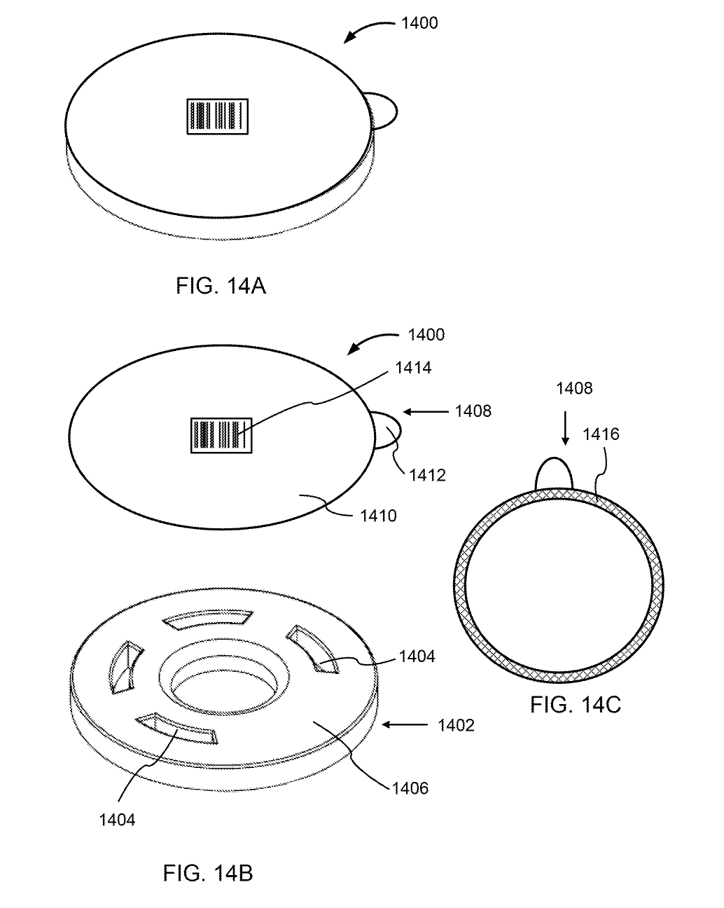

FIG. 14A is an isometric view of the top of a scent cartridge 1400, according to one illustrated embodiment. FIG. 14B is an exploded view of the top of the scent cartridge 1400. The scent cartridge 1400 is similar to the scent cartridge 1200 shown in FIGS. 12A-12C. The scent cartridge 1400 includes an end portion 1402 having four wedge-shaped apertures 1404 and a sealed portion 1406, which is provided between two of the apertures 1404. The surface area of the sealed portion 1406 may be less than, greater than, or equal to the surface area of each of the apertures 1404.

The scent cartridge 1400 also includes one or more hermetically sealed membranes 1408. The hermetically sealed membrane 1408 may be formed from tin foil, aluminum foil, or a foil formed from an alloy thereof, for example. The hermetically sealed membrane 1408 includes a main portion 1410, a tab 1412, and a contents indicator 1414 formed on an upper surface of the main portion 1410.

The contents indicator 1414 may include a picture, text, and/or a computer-readable structure (e.g., a barcode or RFID tag) indicating the particular scents, aromas, or other items contained in each of the chambers of the scent cartridge 1400. For example, the contents indicator 1414 may indicate that a first specified chamber includes particles having a first scent (e.g., the scent of hazelnut coffee), a second specified chamber includes particles having a second scent (e.g., the scent of espresso), a third specified chamber includes particles having a third scent (e.g., the scent of Kona coffee), that a forth specified chamber includes particles that neutralize odors (e.g., baking soda), and that a fifth specified chamber is empty. In one embodiment, the contents indicator 1414 is provided on a housing of the cartridge 1400.

FIG. 14C shows a bottom plan view of the hermetically sealed membrane 1408. A pressure sensitive adhesive 1416 is provided about a peripheral portion of a lower surface of the hermetically sealed membrane 1408. The hermetically sealed membrane 1408 may be placed above the first end portion 1402 and advanced toward the first end portion 1402 until the pressure sensitive adhesive 1416 contacts an upper surface of the first end portion 1402. Pressure may be applied to the upper surface of the main portion 1410 of the hermetically sealed membrane 1408 such that the main portion 1410 forms a seal around the apertures 1404 and prevents air and moisture from flowing from through the apertures 1404, which can degrade the scent media included in chambers of the scent cartridge 1400. The hermetically sealed membrane 1408 may be removed from the first end portion 1402 prior to use of the cartridge 1400, and may be reattached to the first end portion 1402 after use of the cartridge 1400 to protect the scent media therein. The cartridge 1400 also may include a second hermetically sealed membrane 1408 that can be attached to a second end portion of the cartridge 1400 that is similar to the second end portion 1212 shown in FIG. 12C.

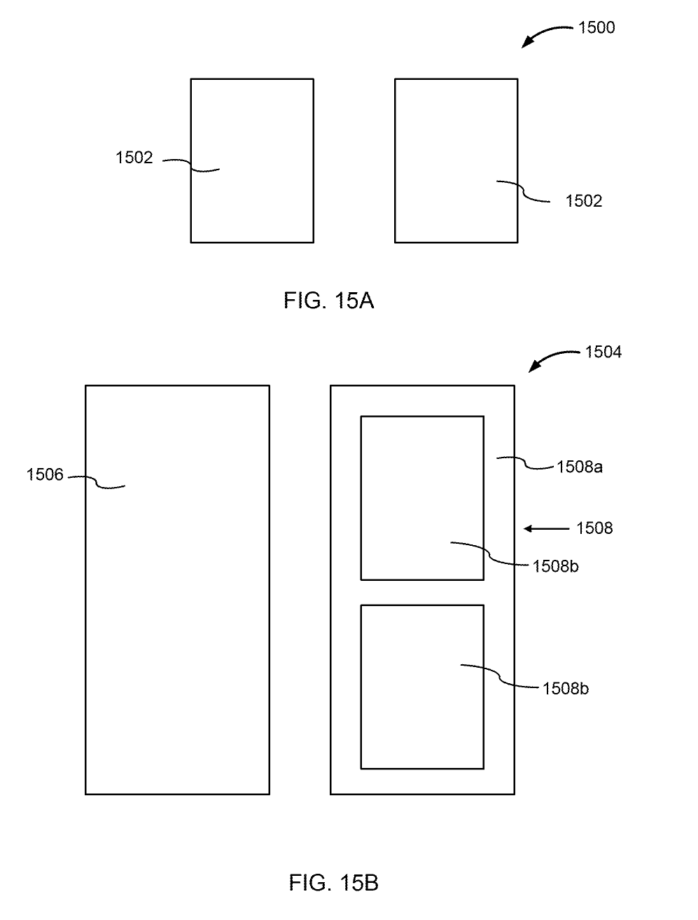

FIG. 15A is an exploded view of a pouch 1500 according to one illustrated embodiment. The pouch 1500 includes one or more side portions 1502. In one embodiment, the pouch 1500 includes two side portions 1502 formed of a plastic material that does not enable air and moisture to pass therethrough. One or more scent cartridges (e.g., cartridge 1200) are placed between the side portions 1502, and corresponding edges of the side portions 1502 are welded together such that an air tight and moisture proof pouch is formed around the cartridge, which protects the contents of the cartridge prior to use of the cartridge. In one embodiment, one side portion 1502 is provided, which is folded around one or more scent cartridges, and corresponding edges of the side portion 1502 are welded together to form an air tight and moisture proof pouch around the cartridges. In one embodiment, the pouch 1500 includes a desiccant (e.g., calcium oxide or silica gel) that can absorb moisture that may be contained in the pouch 1500 after the pouch 1500 is sealed.

FIG. 15B is an exploded view of a scent cartridge blister pack 1504 according to one illustrated embodiment. The blister pack 1504 includes a backing substrate 1506 and a blister substrate 1508. The blister substrate 1508 includes a border portion 1508a and one or more compartments 1508b that extend outwardly from a first surface of the blister substrate 1508. After a scent cartridge is placed in each of the compartments 1508b, an adhesive is applied to the border portion 1508a on a second surface opposite the first surface of the blister substrate 1508, and the backing substrate 1506 is brought into contact with the adhesive on the border portion 1508a. The backing substrate 1506 hermetically seals each of the compartments 1508b, thereby protecting the contents of the cartridges sealed therein from external air and moisture. In one embodiment, each of the compartments 1508b includes a desiccant (e.g., calcium oxide or silica gel) that can absorb moisture that may be contained in the compartments 1508b after the compartments 1508b are sealed.

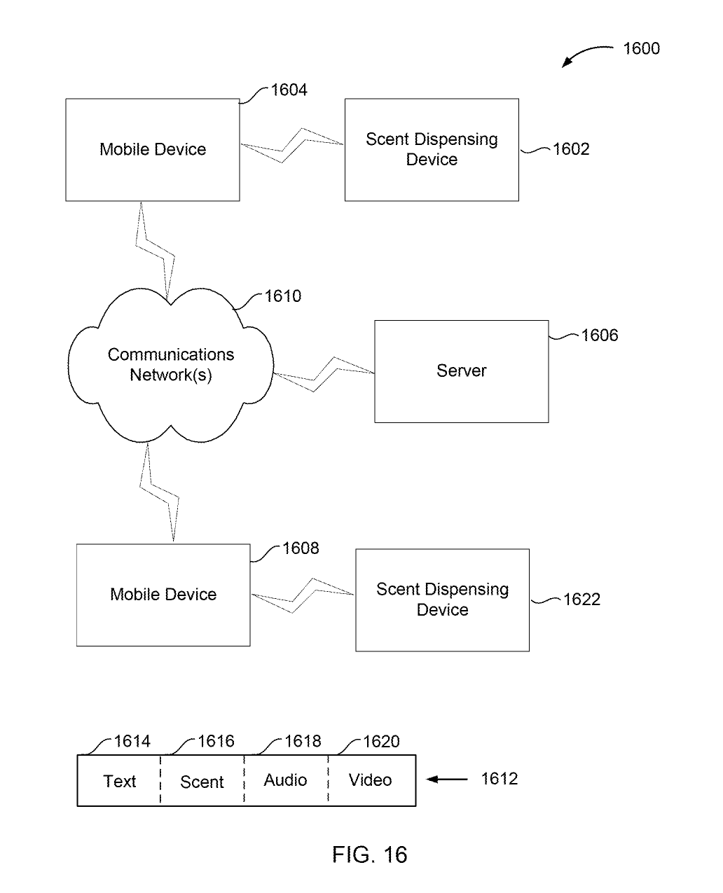

FIG. 16 is a network diagram of a scent dispensing system 1600 according to one illustrated embodiment. The scent dispensing system 1600 includes a first scent dispensing device 1602, a first mobile device 1604, a server 1606, at least a second scent dispensing device 1622, and at least a second mobile device 1608. One or more communications networks 1610 provide communications paths between the first mobile device 1604, the server 1606, and the second mobile device 1608. The first scent dispensing device 1602 and the first mobile device 1604 communicate via wired or wireless communications. In one embodiment, the first scent dispensing device 1602 and the first mobile device 1604 communicate via Bluetooth® communications. Similarly, the second scent dispensing device 1622 and the second mobile device 1608 communicate via wired or wireless communications. For example, the first mobile device 1604 and the first scent dispensing device 1602 may belong to a first user of the system 1600, and the second mobile device 1608 and the second scent dispensing device 1622 may belong to a second user different than the first user.

The first mobile device 1604 and the second mobile device 1608 may be various types of computing devices including, but not limited to, smart phones, tablet computers, desktop computers, notebook computers, in-flight entertainment systems (IFE systems), built-in automotive computing devices, and the like.

As will be explained below, the first mobile device 1604, the server 1606, and/or the second mobile device 1608 may include computer-executable code that, when executed by a processor, generates one or more messages 1612. The messages 1612 may be in the form of a “digital post” published on a social network service. Each message 1612 may include a text portion 1614, a scent portion 1616, an audio portion 1618, and/or a video portion 1620. The first mobile device 1604 stores a software application including computer-executable instructions that, when executed by a processor, cause the first mobile device 1604 to process the messages 1612. For example, the first mobile device 1604 may begin to execute such instructions when one or more of the messages 1612 are received via one or more applications, such as a text message application, an electronic mail application and/or a social media application. Non-limiting examples of social media applications include Facebook®, Twitter®, Instagram®, Pinterest®, Vine®, Snapchat®, Yelp®, Foursquare®, and Youtube®.

Upon receipt of one or more of the messages 1612 the software application may, for example, instruct or cause the processor to cause a display device (e.g., a touch screen) of the first mobile device 1604 to display the text portion 1614, which may include a description of the scent portion 1616, the audio portion 1618, and/or the video portion 1620 of the message 1612. A user of the first mobile device 1604 may indicate using an input device (e.g., a key pad or touch screen) whether the message 1612 or a sequence of related messages 1612 may be processed further. If the processor receives an indication that the message(s) 1612 are to be processed further, the processor may cause the first mobile device 1604 to send information corresponding to the scent portion 1616 to the first scent dispensing device 1602. The processor also may cause a speaker to produce one or more sound(s) corresponding to the audio portion 1618 and/or a display device to display one or more image(s) corresponding to the video portion 1620.

Additionally, one or more software applications may include computer-executable instructions for gathering information regarding the contents of scent cartridges (e.g., scent cartridges 900, 1200, or 1400). For example, the software application may enable a user to indicate that one or more scent cartridges are being or have been loaded into the first scent dispensing device 1602. In response, the software application instructs the processor to cause a display device (e.g., a tough screen) of the first mobile device 1604 to display a series of prompts for a user to input information regarding each cartridge that has been or is being loaded into the first scent dispensing device 1602. Such information may include information regarding a particular location within the first scent dispensing device 1602 (e.g., a particular scent cartridge receptacle 1012b of a scent cartridge holder 1012) and information regarding the contents of each scent chamber (e.g., an identifier of each scent chamber 1232 and an identifier of the contents thereof). For example, the user may respond to the prompts indicating that the front, right scent cartridge receptacle 1012b has been loaded with a scent cartridge that includes five chambers, wherein a first predefined chamber contains a first scent, a second predefined chamber contains a second scent, a third predefined chamber contains a third scent, a fourth predefined chamber contains an odor neutralizer (e.g., baking soda, activated carbon), and a fifth predefined chamber is empty.

Additionally or alternatively, the software application may cause the display device of the first mobile device 1604 to display a message instructing the user to place a machine-readable symbol (e.g., barcode symbol) included with the scent cartridge within the field of view of a camera of the first mobile device. The software application may then instruct the processor to cause the camera to take or capture an image and to process corresponding image data to obtain the information regarding the contents of the cartridge. In this case, the user may simply enter information regarding the location within the first scent dispensing device 1602 (e.g., a particular scent cartridge receptacle 1012b of a scent cartridge holder 1012) in which the cartridge is being or has been placed. After the software application has caused the processor to store information regarding the contents and locations of the cartridges loaded within the first scent dispensing device 1602 into a memory of the first mobile device 1604, the application can process the messages 1612.

In some embodiments, the scent cartridge 1200 may include a memory 1238 that stores information regarding its contents, and electrical contacts 1236 (FIG. 12B) for facilitating access to the memory. The scent dispensing device 1000 may include one or more corresponding electrical contacts to capture the information regarding the contents of the scent cartridge. For example, in the embodiment shown in FIG. 11A, each of the scent cartridge receptacles 1012b includes electrical contacts 1024 (only one shown) that interface with corresponding electrical contacts 1236 on the scent cartridge. Using the electrical connection, the scent dispensing device 1602 is able to obtain the information regarding the contents of the scent cartridge and to transmit the information to the first mobile device 1604, which may transmit the information to the server 1606. The electrical contacts 1236 may be positioned at any location on the scent cartridge 1200. For example, existence of an electrical connection may be interpreted as a “1” while absence of an electrical connection may be interpreted as a “0,” thereby forming a binary pattern (e.g., byte, word) which encodes information (e.g., identifier, type) about the scent cartridge 1200. In some embodiments, in addition to or instead of the electrical contacts 1236, the scent cartridge 1200 may include a wireless transponder (e.g., an RFID tag or transponder) encoding information that is readable by a component of the scent dispensing device 1000.

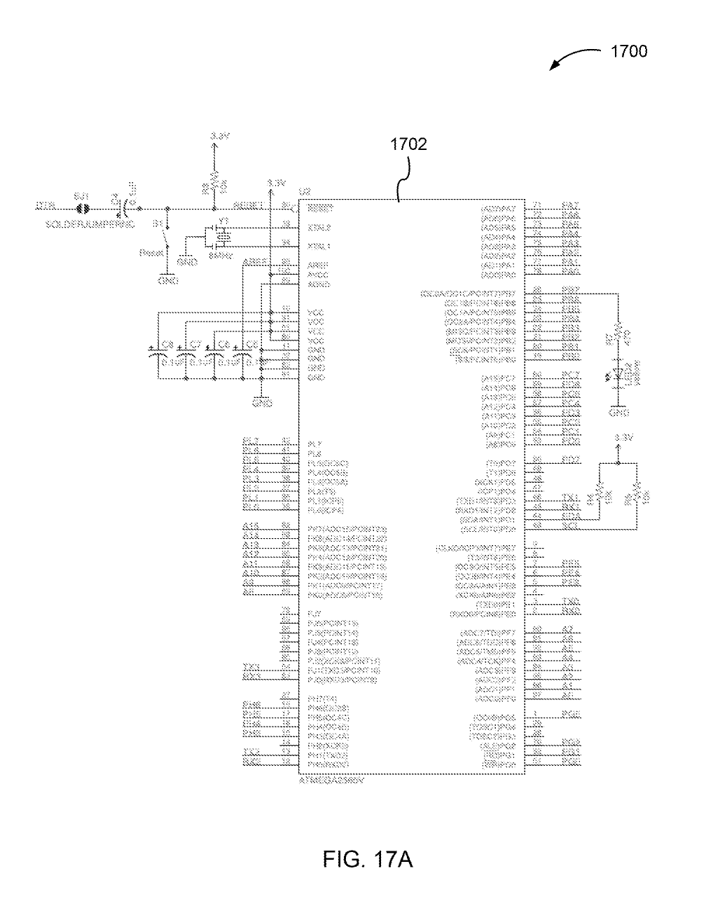

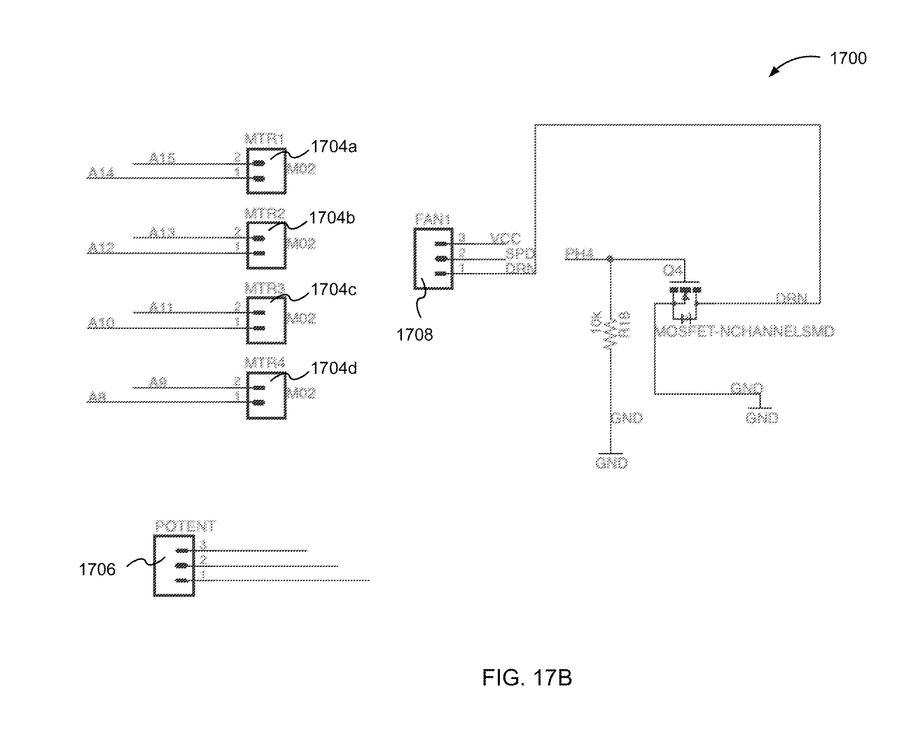

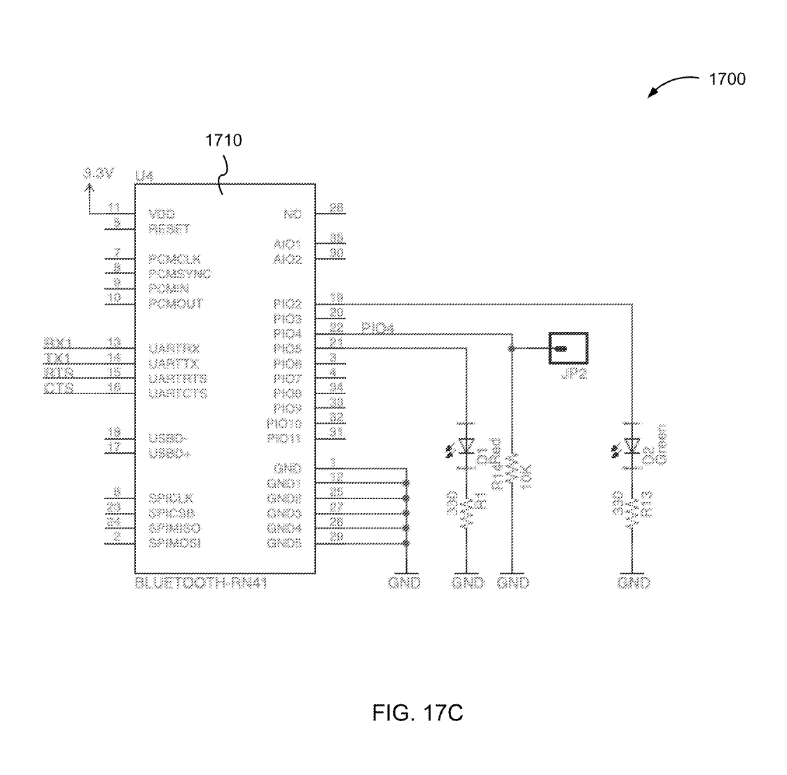

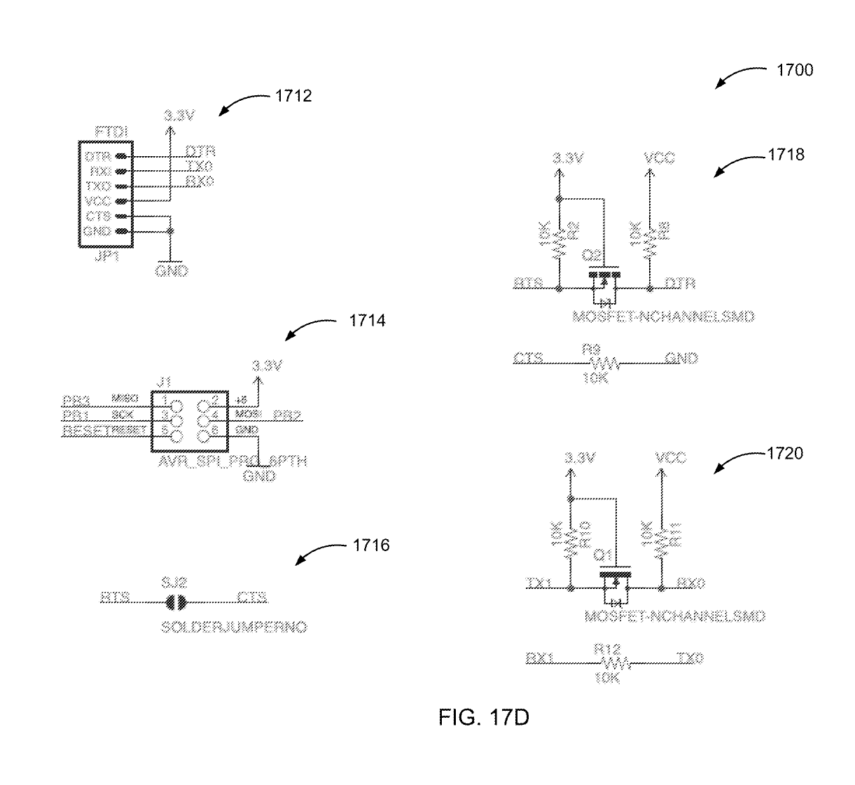

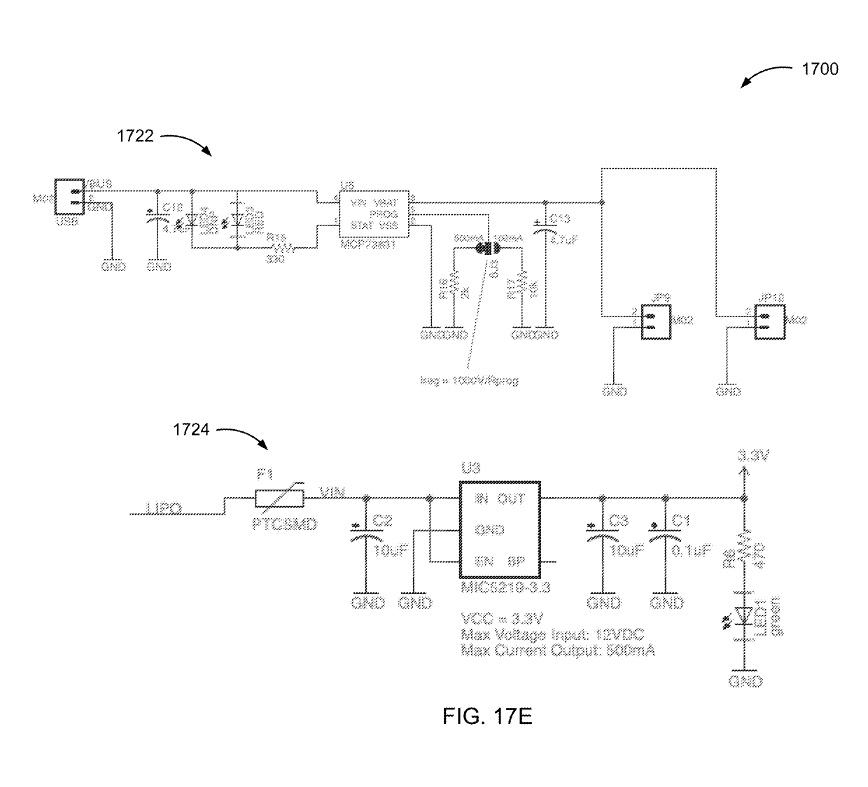

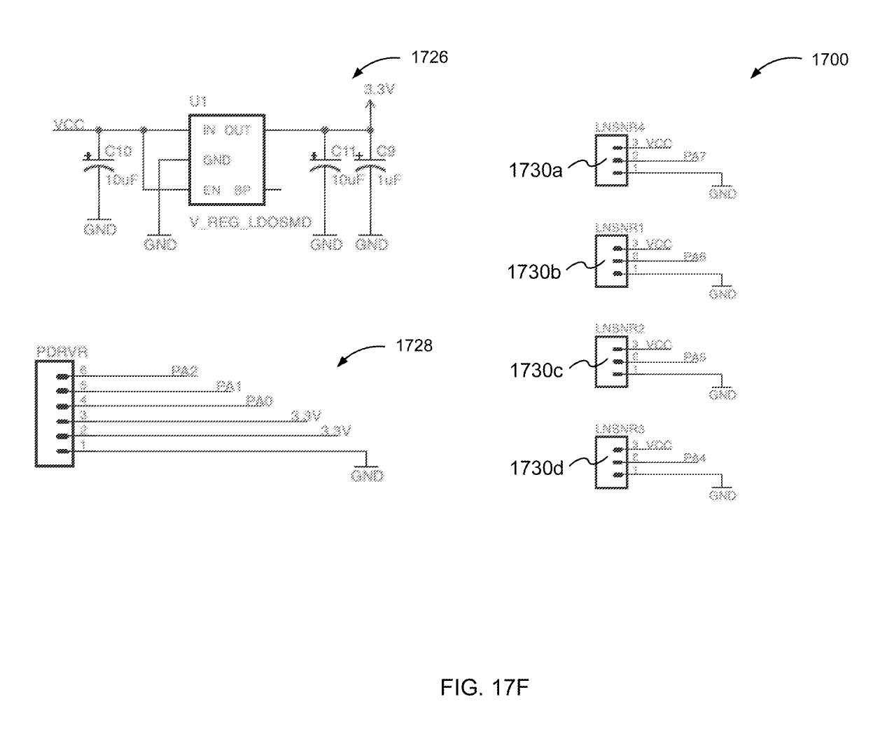

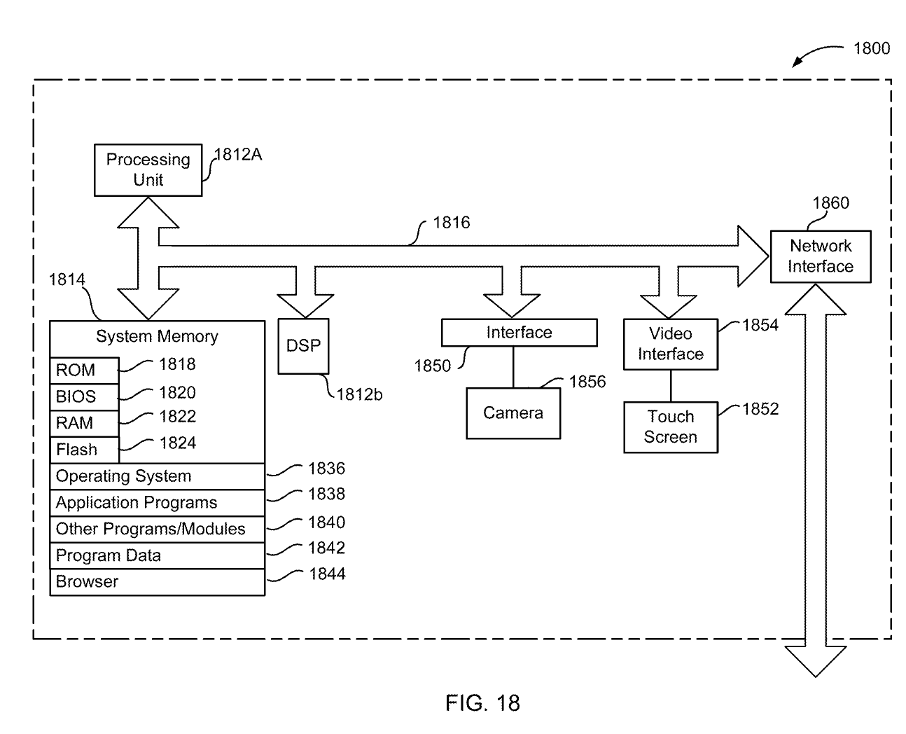

FIGS. 17A-17F illustrate various portions of a schematic diagram of a computing device 1700 according to one illustrated embodiment. The computing device 1700 may be used to implement the first scent dispensing device 1602 (or the second scent dispensing device 1622) shown in FIG. 16. The computing device 1700 includes a microcontroller 1702, four stepper motors 1704a-1704d (collectively 1704), a slide potentiometer 1706, a fan 1708, and a Bluetooth® communications module 1710. In one embodiment, the microcontroller 1702 is a model ATMEGA2560V microcontroller by Atmel Corporation. The computing device 1700 also includes circuits 1712, 1714, 1716, 1718, 1720, 1722, 1724, 1726, and 1728, which perform various functions such as regulating power, charging batteries, monitoring battery levels, distributing power, biasing components, and processing USB communications. Additionally, the computing device 1700 may include four sensors 1730a-1730d (e.g., cameras) that can provide image data that the microcontroller 1702 can process to determine one or more orientations/positions of one or more scent cartridges. FIG. 18 is a block diagram of a computer system 1800 according to one illustrated embodiment. The computer system 1800 may be used to implement the first mobile device 1604 and/or the second mobile device 1608 shown in FIG. 16. The computer system 1800 is suitable for facilitating generation and processing of scent messages (e.g., message 1612). The computer system 1800 may include one or more processing units 1812a and 1812b (collectively processing unit 1812), a system memory 1814 and a system bus 1816 that couples various system components including the system memory 1814 to the processing units 1812. The processing unit 1812 may be any logic processing unit, such as one or more central processing units (CPUs) 1812a, digital signal processors (DSP) 1812b, application-specific integrated circuits (ASICs), field programmable gate arrays (FPGAs), etc. The system bus 1816 can employ any known bus structures or architectures, including a memory bus with memory controller, a peripheral bus, and a local bus. The system memory 1814 includes read-only memory (ROM) 1818, random access memory (RAM) 1822, and flash memory 1824. A basic input/output system (BIOS) 1820, which can form part of the ROM 1818, contains basic routines that help transfer information between elements within the computer system 1800, such as during start-up.

The computer system 1800 may also include a plurality of interfaces such as network interface 1860 and interface 1850 supporting any other wireless/wired interfaces. Computer-readable storage media can be used to store the information that may be accessed by processing unit 1812a. For example, such computer-readable storage media may include, but is not limited to, random access memory (RAM), read-only memory (ROM), electrically erasable programmable read-only memory (EEPROM), flash memory, or other solid state memory or any other medium.

Program modules can be stored in the system memory 1814, such as an operating system 1836, one or more programs 1838, other programs or modules 1840, and program data 1842. Programs 1838 may include instructions that cause the processor unit(s) 1812 to generate, process, and/or receive scent messages and scent information. Other program modules 1840 may include instructions for handling security such as password or other access protection and communications encryption. The system memory 1814 may also include communications programs, for example, a Web client or browser 1844 for permitting the computer system 1800 to access and exchange data with sources such as Web sites of the Internet, corporate intranets, extranets, or other networks and devices as described herein, as well as other server applications on server computing systems. The browser 1844 in the depicted embodiment is markup language based, such as Hypertext Markup Language (HTML), Extensible Markup Language (XML) or Wireless Markup Language (WML), and operates with markup languages that use syntactically delimited characters added to the data of a document to represent the structure of the document. A number of Web clients or browsers are commercially available such as those from Mozilla, Google, and Microsoft.

An operator can enter commands and information into the computer system 1800 through input devices such as a touch screen 1852, and/or via a graphical user interface. Other input devices can include a microphone, a pointing device, etc. These and other input devices, such as camera unit 1856, are connected to one or more of the processing units 1812 through the interface 1850 such as a serial port interface that couples to the system bus 1816, although other interfaces such as a parallel port, a game port or a wireless interface or a universal serial bus (USB) can be used. The touch screen device 1852 or other display device is coupled to the system bus 1816 via a video interface 1854, such as a video adapter.

The computer system 1800 can operate in a networked environment using logical connections to one or more remote computers and/or devices as described above with reference to FIG. 16. For example, the computer system 1800 can operate in a networked environment using logical connections to one or more mobile devices, landline telephones and other service providers or information servers. Communications may be via a wired and/or wireless network architecture, for instance wired and wireless enterprise-wide computer networks, intranets, extranets, telecommunications networks, cellular networks, paging networks, and other mobile networks.

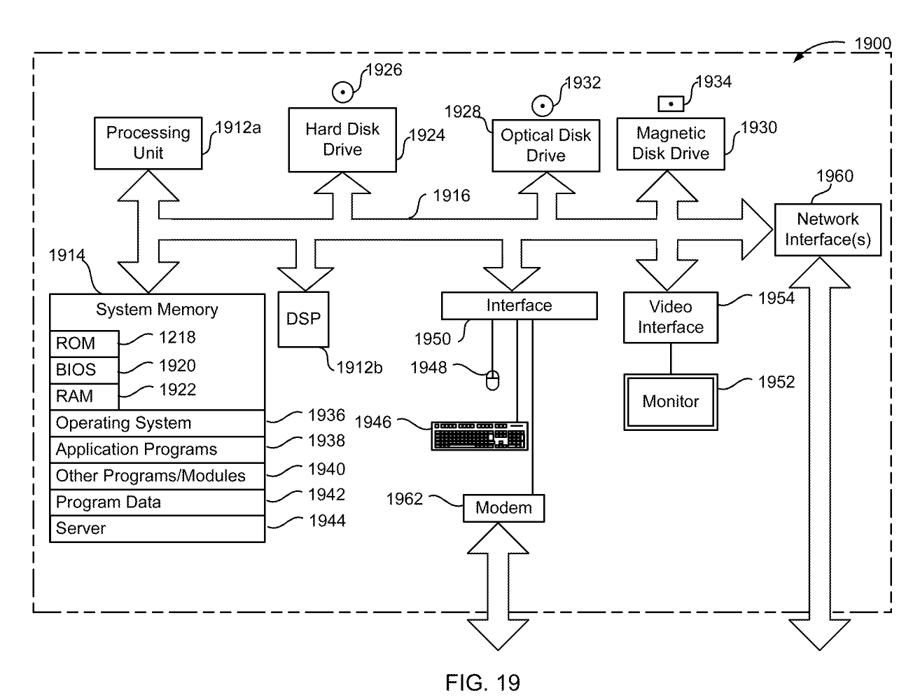

FIG. 19 shows an example computer system 1900, according to one illustrated embodiment. The computer system 1900 may be used to implement the server 1606 shown in FIG. 16. For example, the server 1606 in some embodiments may be used to implement a social network service or a scent messaging service. The computer system 1900 will at times be referred to in the singular herein, but this is not intended to limit the embodiments to a single device, since in typical embodiments, there may be more than one computer system or device involved. Unless described otherwise, the construction and operation of the various blocks shown in FIG. 19 are of conventional design. As a result, such blocks need not be described in further detail herein, as they will be understood by those skilled in the relevant art.

The computer system 1900 may include one or more processing units 1912a, 1912b (collectively 1912), a system memory 1914 and a system bus 1916 that couples various system components including the system memory 1914 to the processing units 1912. The processing units 1912 may be any logic processing unit, such as one or more central processing units (CPUs) 1912a, digital signal processors (DSPs) 1912b, application-specific integrated circuits (ASICs), field programmable gate arrays (FPGAs), etc. The system bus 1916 can employ any known bus structures or architectures, including a memory bus with memory controller, a peripheral bus, and a local bus. The system memory 1914 includes read-only memory (ROM) 1918 and random access memory (RAM) 1922. A basic input/output system (BIOS) 1920, which can form part of the ROM 1918, contains basic routines that help transfer information between elements within the computer system 1900, such as during start-up.

The computer system 1900 may also include a plurality of interfaces such as a network interface 1960 and an interface 1950 supporting a modem 1962 or any other wireless/wired interfaces.

The computer system 1900 may include a hard disk drive 1924 for reading from and writing to a hard disk 1926, an optical disk drive 1928 for reading from and writing to removable optical disks 1932, and/or a magnetic disk drive 1930 for reading from and writing to magnetic disks 1934. The optical disk 1932 can be a CD-ROM, while the magnetic disk 1934 can be a magnetic floppy disk or diskette. The hard disk drive 1924, optical disk drive 1928 and magnetic disk drive 1930 may communicate with the processing unit 1912 via the system bus 1916. The hard disk drive 1924, optical disk drive 1928 and magnetic disk drive 1930 may include interfaces or controllers (not shown) coupled between such drives and the system bus 1916, as is known by those skilled in the relevant art. The drives 1924, 1928 and 1930, and their associated computer-readable storage media 1926, 1932, 1934, may provide non-volatile and non-transitory storage of computer-readable instructions, data structures, program modules and other data for the computer system 1900.

Although the depicted computer system 1900 is illustrated employing the hard disk drive 1924, optical disk drive 1928 and magnetic disk drive 1930, those skilled in the relevant art will appreciate that other types of computer-readable storage media that can store data accessible by a computer may be employed, such as magnetic cassettes, flash memory, Bernoulli cartridges, RAMs, ROMs, smart cards, etc. For example, computer-readable storage media may include, but is not limited to, random access memory (RAM), read-only memory (ROM), electrically erasable programmable read-only memory (EEPROM), flash memory, compact disc ROM (CD-ROM), digital versatile disks (DVD) or other optical disk storage, magnetic cassettes, magnetic tape, magnetic disk storage or other magnetic storage devices, solid state memory or any other medium which can be used to store the desired information and which may be accessed by processing unit 1912a.

Program modules can be stored in the system memory 1914, such as an operating system 1936, one or more programs 1938, other programs or modules 1940, and program data 1942. Programs 1938 may include instructions that cause the processor(s) 1912 to generate, process, transmit, and/or receive scent messages 1612 and scent information. Other program modules 1940 may include instructions for handling security such as password or other access protection and communications encryption. The system memory 1914 may also include communications programs, for example, a Web server 1944 for permitting the computer system 1900 to be accessed and exchange data with Web browsers of the Internet, corporate intranets, extranets, or other networks and devices as described herein, as well as other server applications on server computing systems. The Web server 1944 in the depicted embodiment is markup language based, such as Hypertext Markup Language (HTML), Extensible Markup Language (XML) or Wireless Markup Language (WML), and operates with markup languages that use syntactically delimited characters added to the data of a document to represent the structure of the document. A number of Web clients or browsers are commercially available such as those from Mozilla, Google, and Microsoft.

While shown in FIG. 19 as being stored in the system memory 1914, all or portions of the operating system 1936, programs 1938, other programs/modules 1940, program data 1942 and server 1944 can be stored on the hard disk 1926 of the hard disk drive 1924, the optical disk 1932 of the optical disk drive 1928 and/or the magnetic disk 1934 of the magnetic disk drive 1930.

An operator can enter commands and information into the computer system 1900 through input devices such as keyboard 1946 and/or a pointing device such as a mouse 1948, and/or via a graphical user interface. Other input devices can include a microphone, joystick, game pad, tablet, scanner, etc. These and other input devices are connected to one or more of the processing units 1912 through an interface 1950 such as a serial port interface that couples to the system bus 1916, although other interfaces such as a parallel port, a game port or a wireless interface or a universal serial bus (USB) can be used. A monitor 1952 or other display device is coupled to the system bus 1916 via a video interface 1954, such as a video adapter. The computer system 1900 can include other devices, such as speakers, printers, etc.

The computer system 1900 can operate in a networked environment using logical connections to one or more remote computers and/or devices as described above with reference to FIG. 16. For example, the computer system 1900 can operate in a networked environment using logical connections to one or more mobile devices, landline telephones and other service providers or information servers. Communications may be via a wired and/or wireless network architecture, for instance wired and wireless enterprise-wide computer networks, intranets, extranets, telecommunications networks, cellular networks, paging networks, and other mobile networks.

It should be understood that the various techniques described herein may be implemented in connection with hardware, software and/or firmware or, where appropriate, with a combination of such. Thus, the methods and apparatuses of the disclosure, or certain aspects or portions thereof, may take the form of program code (i.e., instructions) embodied in tangible media, such as floppy diskettes, CD-ROMs, DVDs, hard drives, flash drives, or any other machine-readable or processor-readable storage medium wherein, when the program code is loaded into and executed by a machine, such as a processor of a computer or mobile device, the machine becomes an apparatus for practicing various embodiments. In the case of program code execution on programmable computers or mobile devices, such generally includes a processor, a storage medium readable by the processor (including volatile and non-volatile memory and/or storage elements), at least one input device, and at least one output device. One or more programs may implement or utilize the processes described in connection with the disclosure, e.g., through the use of an API, reusable controls, or the like. Such programs are preferably implemented in a high level procedural or object-oriented programming language to communicate with a computer system including the computer system 1900 depicted in FIG. 19. However, the program(s) can be implemented in assembly or machine language, if desired. In any case, the language may be a compiled or interpreted language, and combined with hardware implementations.

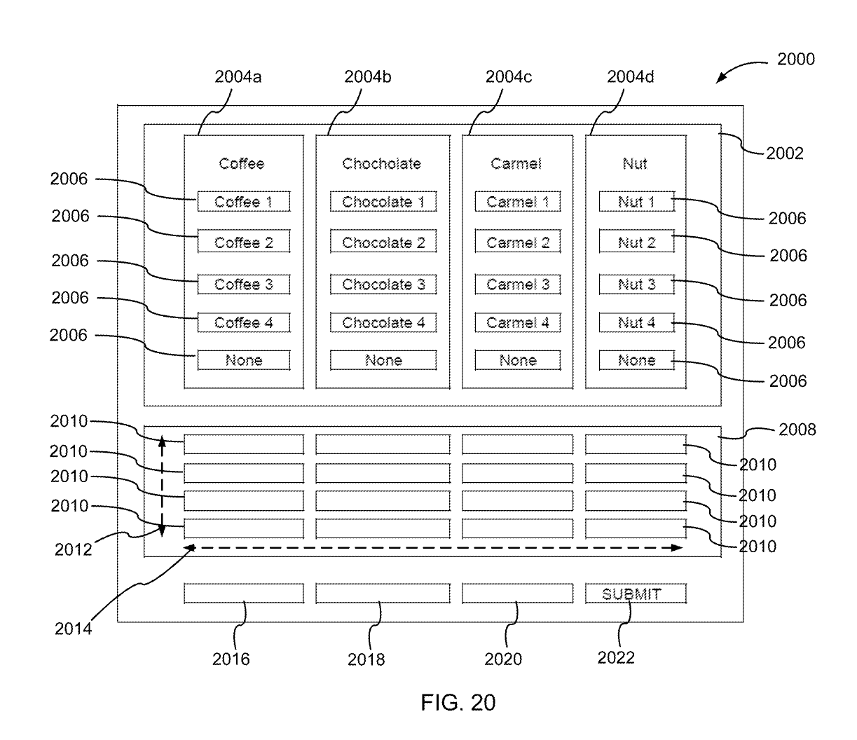

FIG. 20 is block diagram of a scent sequence specification user interface 2000 according to one illustrated embodiment. The scent sequence specification user interface 2000 may be provided by the server 1606. The scent sequence specification user interface 2000 may additionally or alternatively be provided by the applications programs 1838 of the system 1800. For example, the server 1606 may provide HTML formatted information corresponding to the scent sequence specification user interface 2000 to the second mobile device 1608. When the second mobile device 1608 receives the information, a processor of the device (e.g., processing unit 1812a) causes a display device (e.g., touch screen 1852) to display the scent sequence specification user interface 2000. When a user selects icons or inputs text (e.g., via the touch screen 1852), the processor of the second mobile device 1608 causes corresponding information to be transmitted to the server 1606 via the network 1610. As will be explained, a processor (e.g., processing unit 1912a) of the server 1606 executes predetermined instructions (e.g., that are stored in the programs 1938) in response to receipt of information from the first mobile device 1604 and/or the second mobile device 1608.

The scent sequence specification user interface 2000 includes a scent palette 2002 that includes four categories of scents 2004a-2004d. The first category of scents 2004a includes four different coffee scents. The second category of scents 2004b includes four different chocolate scents. The third category of scents 2004c includes four different caramel scents. The fourth category of scents 2004d includes four different nut scents. The categories of scents 2004a-2004d include twenty selectable icons 2006, each of which indicates a particular scent (or absence of a scent). For example, one or more of the selectable icons 2006 may include text, symbols, and/or pictures that represent a particular scent.

The scent sequence specification user interface 2000 also includes a two-dimensional array of scent specification fields 2008. The array of scent specification fields 2008 includes sixteen text input boxes 2010. The text input boxes 2010 are arranged along a first axis 2012 and a second axis 2014, which is perpendicular to the first axis 2012. A distribution of the scent specifications fields (e.g., text input boxes 2010) along the first axis 2012 of the array of scent specification fields 2008 represents a position in a temporal sequence. For example, the scents specified via the text input boxes 2010 in the top row of the array of scent specification fields 2008 may be produced before the scents specified via the text input boxes 2010 in the bottom row of the array of scent specification fields 2008. A distribution of the scent specification fields (e.g., text input boxes 2010) along the second axis 2014 of the array of scent specification fields 2008 represents one or more scents to be dispensed at a respective position in the temporal sequence. For example, the scents specified via the text input boxes 2010 in a first row of the array of scent specification fields 2008 may be produced at a first time, the scents specified via the text input boxes 2010 in a second row of the array of scent specification fields 2008 may be produced at a second time, etc. That is, the scents specified via the text input boxes 2010 in each of the rows of the array of scent specification fields 2008 may represent a compound scent that is a mixture or combination of the scents specified via the input boxes 2010 in that row. Additionally, the scents specified via the text input boxes 2010 in the four illustrated rows of the array of scent specification fields 2008 may represent a sequence of four such compound scents.

When each of the selectable icons 2006 is selected, the server 1606 causes one of the text input boxes 2010 to display corresponding text. For example, if a user of the second mobile device 1608 selects the selectable icon 2006 labeled “Coffee 1,” the second mobile device 1608 sends the server 1606 information indicating that the selectable icon 2006 has been selected and, in response, the server 1606 causes the top text input box 2010 under the first category of scents 2004a to display “Coffee 1.” The scent sequence specification user interface 2000 also includes a text input box 2016, a text input box 2018, a text input box 2020, and a submit button 2022.

The server 1606 may initially enable the text input boxes 2010 in the first row (e.g., top row) of the two-dimensional array of scent specification fields 2008 to be populated, and then the scent specification fields 2008 in the second row, and so on. The scent sequence specification user interface 2000 may include a display area (not shown) in which instructions are displayed. The instructions may indicate that the scent sequence specification user interface 2000 can be used to generate up to four scent messages, each of which specifies a user-defined combination of up to four scents. The instructions may indicate that a theme or a name to be associated with the scent messages can be specified by entering text into the text input box 2016, that a sender to be associated with the scent messages can be specified by entering text into the text input box 2018, and that a recipient of the scent messages can be specified by entering text (e.g., an e-mail address) into the text input box 2020.

For example, a user of the second mobile device 1608 may initially select the selectable icons 2006 labeled “Coffee 1,” “Chocolate 1,” “Caramel 1,” and “Nut 1,” respectively, which causes the server 1606 to populate the text input boxes 2010 of the first row of the array of scent specification fields 2008 with text corresponding to the labels of the selectable icons 2006 that were selected. The user may then select the selectable icons 2006 labeled “Coffee 2,” “Chocolate 2,” “Caramel 2,” and “Nut 2,” respectively, which causes the server 1606 to populate the text input boxes 2010 of the second row of the array of scent specification fields 2008 with text corresponding to the labels of the selectable icons 2006 that were selected. The user may then select the selectable icons 2006 labeled “Coffee 3,” “Chocolate 3,” “Caramel 3,” and “None,” respectively, which causes the server 1606 to populate the text input boxes 2010 of the third row of the array of scent specification fields 2008 with text corresponding to the labels of the selectable icons 2006 that were selected. The user may then select the selectable icons 2006 labeled “Coffee 4,” “None,” “Caramel 1,” and “None,” respectively, which causes the server 1606 to populate the text input boxes 2010 of the fourth row of the array of scent specification fields 2008 with text corresponding to the labels of the selectable icons 2006 that were selected. The user may then enter a name or description to be associated with the selected scent combinations in the text input box 2016. The user also may enter her name in the text input box 2018, and an e-mail address of an intended recipient in the text input box 2020, and then select the submit button 2022.

In response, the server 1606 generates a scent specification file including a sequence of four scent messages 1612, each of which includes indicators of the scents specified in one of the rows of the array of scent specification fields 2008. Generally, a scent specification file is composed of a series of time-dependent instructions to enable a scent dispensing device to generate a desired set of scents. A scent specification file serves to depict the progression of the delivery of those scents. The modulation of scent can be a single scent which is released in a rhythmic pattern (e.g., timed pauses, or rests, between the releases of the scent), or a variety of layered scents which change and alternate over time. This progression of scents is associated with a visual representation of the scent progression, shown to the user (e.g., using a display of a mobile device, such as a phone or tablet computer). The scent specification file may also assign the appropriate wired or wireless signals (e.g., Bluetooth®), so that if the application is linked to the scent dispensing device, the proper signals will be transmitted for the scent progression to be released.

In some embodiments, the server 1606 also generates an e-mail message and attaches the scent specification file to the e-mail message and sends the e-mail message using the e-mail address input in the text input box 2020. Instead of or in addition to an email message, the server 1606 may publish a scent notification or “digital post” to a social network service that includes the scent specification file or a reference thereto that is viewable and selectable by a user of the social network service. The server 1606 also may include a default or user-specified duration (e.g., in seconds) for each scent message. For example, the scent specification file may include information corresponding to the information shown in Table 1 below.

TABLE 1
Scent Specification Name = Alice's scent combinations
From = Alice
To = Bob@example.com

| Scent Message 1A: | Scent Message 1B: |
|---|---|
| Scent 1 = Coffee 1 | Scent 1 = Coffee 2 |
| Scent 2 = Chocolate 1 | Scent 2 = Chocolate 2 |
| Scent 3 = Caramel 1 | Scent 3 = Caramel 2 |
| Scent 4 = Nut 1 | Scent 4 = Nut 2 |
| Duration = 10 | Duration = 10 |
| Scent Message 1C: | Scent Message 1D: |
| Scent 1 = Coffee 3 | Scent 1 = Coffee 4 |
| Scent 2 = Chocolate 3 | Scent 2 = None |
| Scent 3 = Caramel 3 | Scent 3 = Caramel 1 |
| Scent 4 = None | Scent 4 = None |
| Duration = 10 | Duration = 10 |

Each scent message portion 1A-1D of the scent message may be referred to as a “scent measure,” similar to a bar or measure in music terminology. When the e-mail message from the server 1606 is received at the first mobile device 1604, a user may open the message and select the attached file, which causes a processor of the first mobile device 1604 (e.g., processing unit 1812a) to execute an application for processing the scent specification file. The application may cause the processor to display a user interface on a touch screen (e.g., on the touch screen 1852). For example, the application may instruct the processor to cause a user interface to be displayed that displays a message indicating a name or theme of the scent messages (e.g., the text entered into the text input box 2016), from whom the message was sent (e.g., the text entered into the text input box 2018). Additionally, the displayed message may indicate the amount of time required for the scents specified in the scent specification file. For example, the processor may add the time durations specified in each scent measure and cause the resulting sum to be displayed in the message. The user interface also may include selectable icons labeled “Continue,” and “Cancel,” for example. The displayed message may indicate that the user can select the “Continue” icon to continue processing the scent messages, and indicate that the user can select the “Cancel” icon at any time to cancel processing of the scent messages.

When the message is sent as a digital post to one or more social network services, the server 1606 may serve the post to a program executing on the first mobile device 1604. The user may select the post (e.g., by clicking on or touching a link, etc.), which causes the program to process the scent specification file as discussed above. In some embodiments, the program may execute one or more additional programs to process the scent specification file. For example, the user may select the post in a social network service application which causes a separate scent processing application to execute and process the scent specification file.

The scent sequence specification user interface 2000 may include categories of scents 2004a-2004d other than those described above. For example, the scents included in the scent sequence specification user interface 2000 may correspond to different flowers, and the scent sequence specification user interface 2000 may be used to create scent combinations and sequences that represent different bouquets of flowers.

Additionally, the scent sequence specification user interface 2000 may be used be to create paragraphs that convey ideas and/or emotions. Each paragraph may include a number of sentences, each of which is comprised of a number of words. Similarly, the scent sequence specification user interface 2000 can be used to generate symphonies of scents, wherein each symphony includes a paragraph.

For example, each of the scents may correspond to a scent that has been observed in a particular city, and the scent sequence specification user interface 2000 may be used to generate paragraphs that represent experiences in that city. A user of the second mobile device 1608 may use the scent sequence specification user interface 2000 to generate a paragraph and cause a corresponding scent specification file to be transmitted to a user of the first mobile device 1604 so that the scent dispensing device 1602 can dispense a combination of scents in a particular sequence that is intended to remind the user of the first mobile device 1604 of a morning the two users had spent together in Paris. A first sentence included in the paragraph may include a number of words or particular scents observed while walking to a café (e.g., the scents of bread and other goods being baked). A second sentence may include a number of words or particular scents observed while dining in the café (e.g., the scents of coffee and croissants). A third sentence may include a number of words or particular scents observed while walking through a park on the way to the metro (e.g., the scents different trees). A fourth sentence may include a number of words or particular scents observed while riding the metro (e.g., the scents of subways and perfumes). A fifth sentence may include a number of words or particular scents observed while walking in the Jardin du Luxembourg (e.g., the scents of different flowers). Similarly, the user of the second mobile device 1608 may use the scent sequence specification user interface 2000 to generate another paragraph that is intended to remind the user of the first mobile device 1604 of another time the two users had spent together in Paris.

In one embodiment, the scent sequence specification user interface 2000 generates sentences according to predetermined grammatical rules. For example, the scent sequence specification user interface 2000 enables a user to select one or more of the selectable icons 2006 to specify: a scent or a scent combination that is the subject of a sentence, a scent or a scent combination that is the verb of the sentence, a scent or a scent combination that is a modifier of the subject of the sentence, and a scent or a scent combination that is a modifier of the verb of the sentence. In response to the user selections, the server 1606 generates information in which the scent corresponding to the subject is specified in one or more predetermined locations in the sequence (e.g., the first scent and the last scent of the sequence), the scent corresponding to the modifier of the subject is included immediately following or immediately the scent corresponding to the subject, the scent corresponding to the verb is repeated a predetermined number of times in the sequence (e.g., 3), and the scent corresponding to the modifier of the verb is included immediately before and/or immediately after each instance of the scent corresponding to the verb.

In one embodiment, the scent sequence specification user interface 2000 enables a user to specify information corresponding to the text portion 1614, the scent portion 1616, the audio portion 1618, and the video portion 1620 of a plurality of messages 1612. For example, the scent sequence specification user interface 2000 may be used to generate a message 1612 having a text portion 1614 that includes a text message, a scent portion 1616 that specifies a scent combination corresponding to the aroma of a particular coffee, an audio portion 1618 that specifies a recording of milk being frothed, and a video portion 1620 that specifies a picture of a cup of coffee. When the scent message 1612 is processed by the first mobile device 1604, a processing unit (e.g., processing unit 1812) of the first mobile device 1604 causes a display device to display the text corresponding to the text portion 1614, causes the first scent dispensing device 1602 to dispense a scent corresponding to the scent portion 1616, causes speakers to emit sounds corresponding to the audio portion 1618, and causes the display device to display a picture corresponding to the video portion 1620. The audio portion 1618 and the video portion 1620 of the message 1612 may include references to attached files and/or links (e.g., URIs) to files that are stored by other devices (e.g., the server 1606).

The software application also may cause information regarding an amount of usage of each scent medium included in each chamber of each scent cartridge to be stored. For example, the software application may cause a first variable and a second variable to be stored for each scent medium, wherein the first variable indicates a number of seconds of actual use time and the second variable indicates a total number of seconds of expected use time. The software application may cause the first variable to be incremented each time the scent medium is used, and cause the second variable to be initialized to a particular value when a scent cartridge containing the scent medium is loaded into a scent dispensing device (e.g., first scent dispensing device 1602). Additionally, the software application may cause a message to be displayed when the actual use time indicated by the first variable exceeds a predetermined threshold (e.g., 90% of the total expected use time indicated by the second variable). In some embodiments, the scent cartridges may include a sensor that senses the amount of each scent medium present in each chamber. For example, in embodiments where the scent medium includes scented wax, a sensor may be provided that senses the stability of the wax remaining in each chamber.

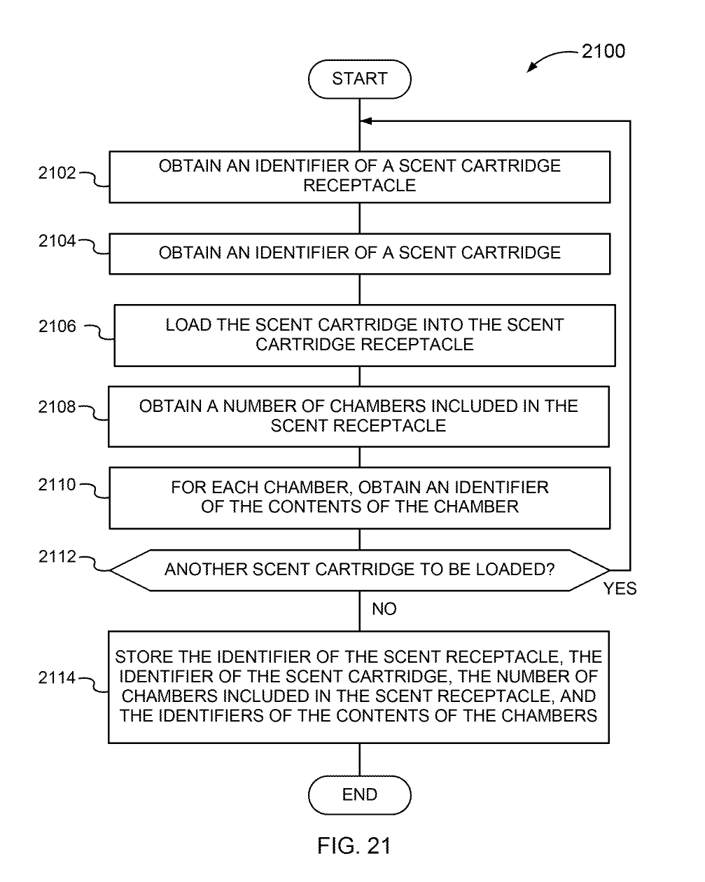

FIG. 21 is a flowchart of a method 2100 of operating the scent dispensing system 1600 shown in FIG. 16, according to one illustrated embodiment. One or more acts included in the method 2100 may be performed by the first mobile device 1604, for example, after a processing unit (e.g., processing unit 1812) of the first mobile device 1604 loads a software application including computer-executable instructions into RAM (e.g., RAM 1822) and executes the instructions. The application may instruct the processing unit to cause a touch screen (e.g., touch screen 1852) to display a series of prompts, receive information input in response to the prompts, and store the received information in program data in system memory (e.g., program data 1842).

At 2102, the processing unit of the first mobile device 1604 causes the touch screen to display a prompt requesting the user to enter an identifier of a scent cartridge receptacle in which a scent cartridge is to be loaded. For example, the identifier of the scent cartridge receptacle may be embossed, printed, provided on a label, or is otherwise visible to the user on an upper surface of one of the axels 1012c of one of the scent cartridge receptacles 1012b of the scent cartridge holder 1012 shown in FIG. 11A. The user may enter the identifier of the scent cartridge receptacle via the touch screen. In response, the processor obtains the identifier of the scent cartridge receptacle and stores it in RAM.

At 2104, the processing unit of the first mobile device 1604 causes the touch screen to display a prompt requesting the user to enter an identifier of the scent cartridge that is to be loaded into the scent cartridge receptacle. For example, the identifier of the scent cartridge may be embossed, printed, provided on a label, or is otherwise visible to the user on an exterior portion of the scent cartridge. The user may enter the identifier of the scent cartridge via the touch screen. In response, the processor obtains the identifier of the scent cartridge and stores it in RAM.

In one embodiment, at 2104, the processing unit of the first mobile device 1604 causes the touch screen to display a prompt requesting the user to take a picture using a camera (e.g., camera unit 1856) of a computer-readable symbol (e.g., barcode) included on the housing 1202 of the scent cartridge 1200 shown in FIG. 12A, or that is included in the contents indicator 1414 formed on the outer surface of the main portion 1410 of the hermetically sealed membrane 1408 shown in FIG. 14A, for example. The processing unit obtains the identifier of the scent cartridge by processing image data corresponding to an image of the computer-readable symbol using conventional techniques. In some embodiments the processing unit of the first mobile device 1604 obtains information about the scent cartridge using wired or wireless communication with the scent cartridge or the first scent dispensing device 1602. For example, in some embodiments the scent cartridge includes electrical contacts communicatively coupled to a memory that stores information about the scent cartridge. The scent cartridge receptacles 1012b may include corresponding electrical contacts operative to couple with the electrical contacts of the scent cartridge to obtain the information from the memory of the scent cartridge. The scent dispensing device may then communicate the information to the first mobile device 1604, which may communicate the information to the server 1606.

At 2106, the user loads the scent cartridge identified at 2104 into the scent cartridge receptacle of the first scent dispensing device 1602 identified at 2102. For example, the user loads the scent cartridge 1200 into one of the scent cartridge receptacles 1012b of the scent cartridge holder 1012 show in FIG. 11A.

At 2108, the processing unit causes the touch screen to display a prompt requesting the user to enter a number of chambers included in the scent cartridge that was loaded into the scent cartridge receptacle of the first scent dispensing device 1602 at 2102. In response, the processing unit obtains the number of chambers and stores the number in RAM. In one embodiment, the processor obtains the number of chambers from image data obtained at 2104.

At 2110, the processing unit causes the touch screen to display a series of prompts requesting the user to enter an identifier of the contents of each of the chambers included in the scent cartridge that was loaded into the scent cartridge receptacle at 2106. In response, the processing unit obtains the identifiers of the contents the chambers and stores them in RAM. In one embodiment, the processor obtains the identifiers of the contents of the chambers from image data obtained at 2104. In another embodiment, the processing unit obtains the identifiers of the contents each of the chambers from system memory. For example, the processing unit obtains the identifiers of the contents of each of the chambers from a table stored in program data, which is associated with the identifier of the scent cartridge obtained at 2104. At 2112, the processing unit determines whether another scent cartridge is to be loaded into the first scent dispensing device 1602. For example, the processing unit causes the touch screen to display a prompt requesting the user to select a selectable icon to indicate whether another scent cartridge is to be loaded. If the user indicates via the touch screen that another scent cartridge is to be loaded, the method returns to 2102. If the user indicates via the touch screen that no other scent cartridge is to be loaded, the method proceeds to 2114.

At 2114, the processing unit causes one or more of the following to be stored in system memory: the identifier of the scent cartridge receptacle obtained at 2102, the identifier of the scent cartridge obtained at 2104, the number of chambers included in the scent cartridge receptacle obtained at 2108, and the identifiers of the contents of the chambers obtained at 2110. For example, the processing unit causes information corresponding to Table 2 or Table 3 below to be stored in program data at 2110.

TABLE 2
Scent Cartridge Receptacle Identifier = A
Scent Cartridge Identifier = CHO001

| Chamber Number | Content Identifier |
|---|---|
| 1 (default) | Empty |
| 2 | Chocolate 1 |
| 3 | Chocolate 2 |
| 4 | Chocolate 3 |
| 5 | Chocolate 4 |

TABLE 3
Scent Cartridge Receptacle Identifier = B
Scent Cartridge Identifier = COF001

| Chamber Number | Content Identifier |
|---|---|
| 1 (default) | Empty |
| 2 | Coffee 1 |
| 3 | Coffee 2 |
| 4 | Coffee 3 |
| 5 | Coffee 4 |

After the information is stored at 2114, the touch screen of the first mobile device 1604 may display a selectable icon that, when selected, causes the processing unit to display a user interface that enables a user to specify scents to be dispensed by the first scent dispensing device 1602. For example, the user interface may include a plurality of selectable icons, wherein each selectable icon includes one of the identifiers of the contents of the chambers obtained at 2110. In response to each of the icons being selected, the processing unit generates a message including a scent specification that identifies a scent corresponding to the selected icon and transmits the message to the first scent dispensing device 1602. After the first scent dispensing device 1602 receives each scent specification, the first scent dispensing device 1602 causes a corresponding scent to be dispensed, as will be explained below.

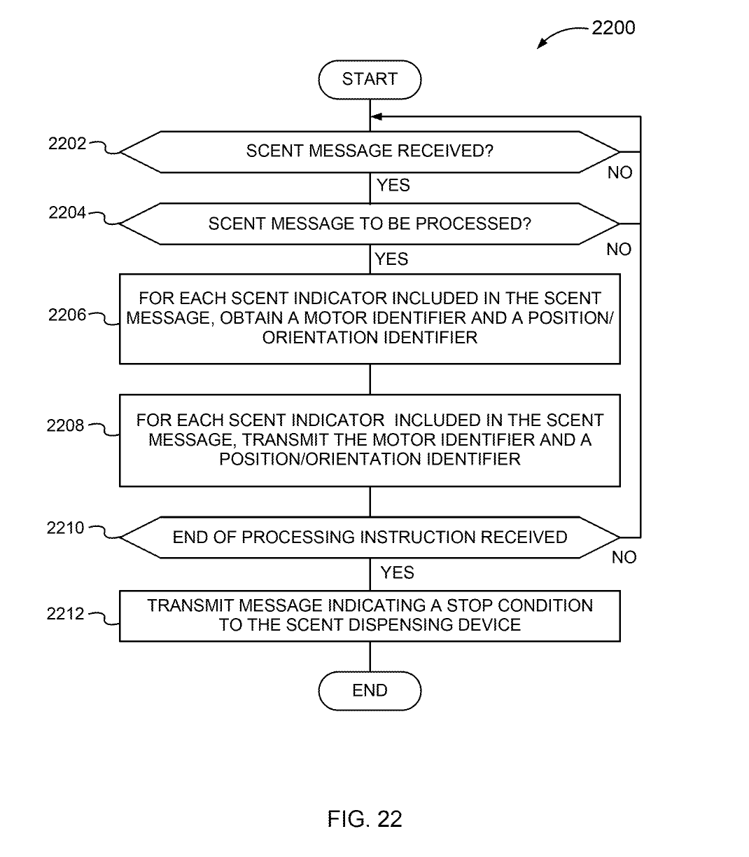

FIG. 22 is a flowchart of a method 2200 of operating the scent dispensing system 1600, according to one illustrated embodiment. One or more acts included in the method 2200 may be performed by the first mobile device 1604, for example, after a processing unit (e.g., processing unit 1812) of the first mobile device 1604 loads a software application including computer-executable instructions into RAM (e.g., RAM 1822) and executes the instructions. The application may instruct the processing unit to cause a touch screen (e.g., touch screen 1852) to display a series of prompts, receive information input in response to the prompts, store the received information in RAM (e.g., RAM 1822) of system memory (e.g., system memory 1814), process and/or transform the received information, and transmit information corresponding to the received information via a network interface (e.g., network interface 1860).

At 2202, the processing unit determines whether a scent message has been received. For example, the processing unit inspects a message buffer in the system memory for the presence of a scent message. If the processing unit determines that a scent message has not been received, the method returns to 2202. If the processing unit determines that a scent message has been received, the method proceeds to 2204.

At 2204, the processing unit determines whether the scent message is to be processed. For example, the processing unit 1812 causes the touch screen to display a prompt requesting the user to select a selectable icon indicating whether the scent message is to be processed. If the processing unit determines that the scent message is not to be processed, the method returns to 2202. If the processing unit determines that the scent message is to be processed, the method proceeds to 2206.

At 2206, the processing unit parses the scent message and identifies each scent indicator included in the scent message. Each scent indicator may indicate, for example, a particular scent (e.g., Chocolate 1) or a lack of particular scent (e.g., an empty chamber or a chamber including a particular type of air filter). For example, the processing unit obtains a first scent identifier of “Coffee 3” and a second scent identifier of “Chocolate 2” from the scent message. The processing unit then obtains a scent cartridge receptacle identifier and a chamber identifier that correspond to the first scent identifier. For example, the processing unit accesses information corresponding to Table 3 above and determines that the scent “Coffee 3” is included in chamber number 4 of the scent cartridge loaded in the scent cartridge receptacle “B,” and also information corresponding to Table 2 above and determines that the scent “Chocolate 2” is included in chamber number 3 of the scent cartridge loaded in the scent cartridge receptacle “A.” The processing unit then obtains the corresponding motor identifiers and position identifiers from information corresponding to Tables 4 and 5 below, for example. That is, the processing unit obtains, from information corresponding to Table 4, a motor identifier of “00,” which corresponds to the scent cartridge receptacle identifier “A” and a motor identifier of “01,” which corresponds to the scent cartridge receptacle identifier “B.” The processing unit also obtains, from information corresponding to Table 5, a position/orientation identifier of “010,” which corresponds to the chamber number 3, and a position/orientation identifier of “011,” which corresponds to the chamber number 4.

TABLE 4

| Scent cartridge receptacle | |
|---|---|
| Identifier | Motor Identifier |
| A | 00 |
| B | 01 |
| C | 10 |
| D | 11 |

TABLE 5

| Chamber Number | Orientation/Position Identifier |
|---|---|
| 1 | 000 |
| 2 | 001 |
| 3 | 010 |
| 4 | 011 |
| 5 | 100 |

At 2208, the processing unit transmits the motor identifier and the position/orientation identifier obtained at 2206 for each scent identifier included in the scent message to the first scent dispensing device 1602. The processing unit may cause a network interface for Bluetooth® communications (e.g., network interface 1860) to transmit a first message for the first scent identifier and a second message for the second scent identifier to the first scent dispensing device 1602. For example, for the first scent identifier of “Coffee 3,” the first message includes a motor identifier of “01” and a position/orientation identifier of “011” and, for the second scent identifier of “Chocolate 2,” the second message includes a motor identifier of “00” and a position/orientation identifier of “010.” The first and the second messages may include other information, for example, network addresses of the first scent dispensing device 1602 and the first mobile device 1604. The first and the second messages may also include other information, such as control information indicating whether each message is the first or last message of a group of messages that create a particular scent combination or sequence of scent combinations.

At 2210, the processing unit determines whether an end of processing instruction has been received. For example, the processing unit 1812 causes the touch screen to display a selectable icon that, when selected, causes the processing unit to receive the end of processing instruction. If the processing unit determines that the end of processing instruction has not been received, the method returns to 2202. If the processing unit determines that the end of processing instruction has been received, the method proceeds to 2212.

At 2212, the processing unit 1812 causes the network interface to transmit a predefined message that indicates a stop condition to the first scent dispensing device 1602. The method 2200 ends after the message is transmitted at 2212.

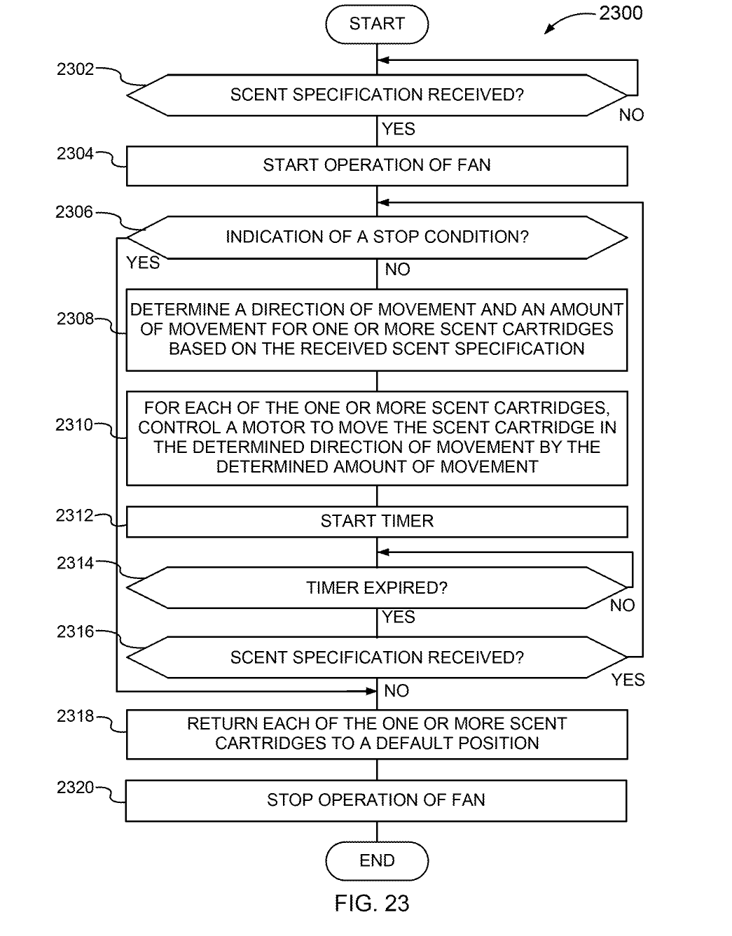

FIG. 23 is a flowchart of a method 2100 of operating the scent dispensing system 1600 shown in FIG. 16, according to one illustrated embodiment. One or more acts included in the method 2300 may be performed by the first scent dispensing device 1602, for example, after a user operates a switch (e.g., slide potentiometer 1706) that causes power to be supplied to the first scent dispensing device 1602. In response, a microcontroller (e.g., microcontroller 1702) causes processor-executable instructions stored in an internal memory to be loaded into an internal RAM and begins executing the instructions.

At 2302, the microcontroller determines whether a scent specification has been received. For example, the microcontroller may inspect an internal Universal Asynchronous Receiver/Transmitter (UART) to determine whether a message from the first mobile device 1604 has been received via a Bluetooth® communications module (e.g., Bluetooth® communications module 1710). The received scent specification may be included in, or correspond to, information included in a scent specification file generated using the scent sequence specification user interface 2000 shown in FIG. 20, for example. If the microcontroller determines that the scent specification has not been received, the method returns to 2302. If the microcontroller determines that the scent specification has been received, the method proceeds to 2304.

At 2304, the microcontroller starts operation of a fan (e.g., fan 1708) by causing an appropriate control signal to be provided to the fan. The particular control signal provided to the fan may depend on the position of a switch (e.g., slide potentiometer 1706). For example, if the switch is at a first position, the microcontroller provides a first control signal to the fan and, if the switch is at a second position, the microcontroller provides a second control signal to the fan, wherein the first control signal causes the fan to rotate faster than the second control signal.

At 2306, the microcontroller determines whether an indication of a stop condition is present. For example, the microcontroller monitors a particular input/output line that is connected to a circuit that provides an indication when the charge remaining in a battery that supplies power to the first scent dispensing device 1602 falls below a predetermined threshold. The predetermined threshold is selected such that the charge remaining in the battery is sufficient to move each of the motors and thus each of the scent cartridges of the first scent dispensing device 1602 to a default position or orientation. At 2306, the microcontroller also may determine whether a predetermined message indicating a stop condition has been received from the first mobile device 1604. If the microcontroller determines that the indication of the stop condition is present, the method proceeds to 2318. If the microcontroller determines that the indication of the stop condition is not present, the method proceeds to 2308.

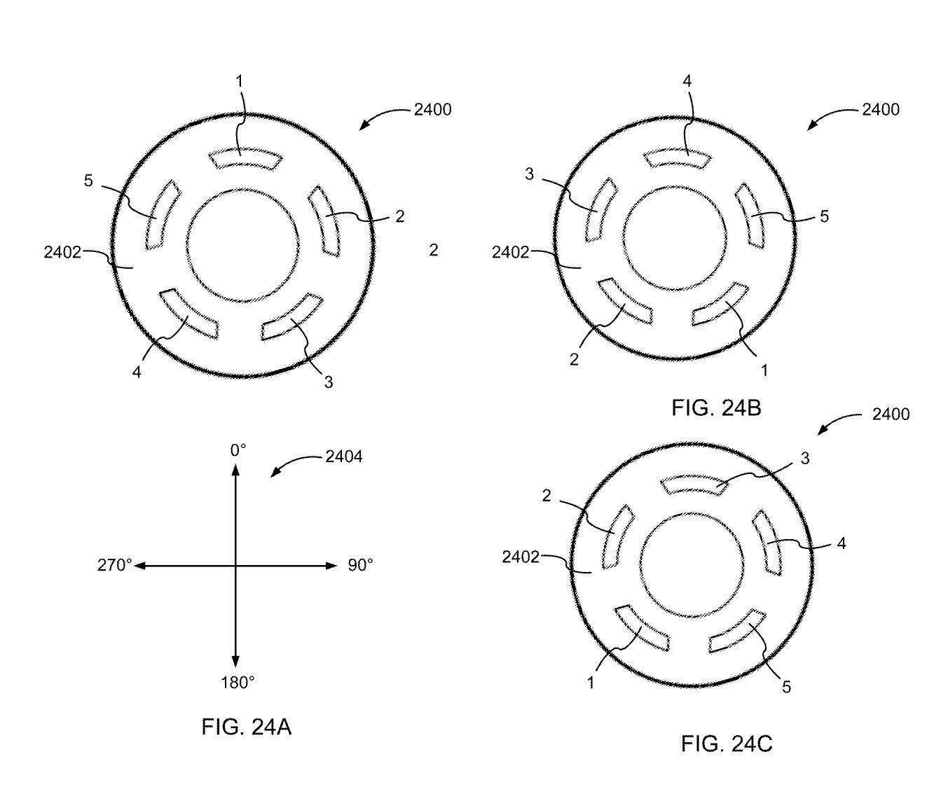

At 2308, the microcontroller determines a direction of movement and an amount of movement of one or more cartridges and/or motors. The acts performed at 2308 will be described with reference to FIGS. 24A-24C. FIG. 24A shows a top plan view of a scent cartridge 2400, according to one illustrated embodiment. An end portion 2402 of the cartridge 2400 includes five apertures that function as outlet ports for five chambers numbered 1-5. The cartridge 2400 shown in FIG. 24A is in a default orientation or position, in which the aperture corresponding to chamber 1 is aligned with an inlet port of a scent mixing chamber (not shown) of the first scent dispensing device 1602. A reference coordinate system 2404 also is shown in FIG. 24A.

For example, the aperture corresponding to chamber 1 may be aligned with an aperture 1014c formed in the bottom portion 1014b of the scent mixing chamber 1014 shown in FIG. 10E. More particularly, the cartridge 2400 may be positioned below the scent mixing chamber 1014 such that a lower surface of the bottom portion 1014b of the scent mixing chamber 1014 is parallel to an upper surface of the end portion 2402 of the cartridge 2400, and the cartridge 2400 is rotated, positioned, or otherwise oriented such that the aperture corresponding to chamber 1 is vertically aligned with the aperture 1014c. For example, the cross-sectional areas of the aperture corresponding to chamber 1 the aperture 1014c are sized and dimensioned the same and, if the cross-sectional area of the aperture 1014c is projected downwardly, the projected area would pass through the aperture corresponding to chamber 1 and would not pass through other areas of the end portion 2402.

Table 6 below shows an example of information that may be stored in internal memory of the microcontroller. In one embodiment, the apertures in the end portion 2402 of the cartridge 2400 have the same size and dimensions, and are uniformly spaced on the end portion 2402 of the cartridge 2400. The orientation of the center of each chamber can be defined by the orientation of a line that starts at the center of the end portion 2402 of the cartridge 2400 and passes through the center of the aperture corresponding to the chamber. The microcontroller can cause the shaft of stepper motors (e.g., stepper motors 1704) to move one step at a time, wherein 200 steps cause one full rotation of the shaft. Table 6 also includes the number of steps that are required to rotate the cartridge 2400 counterclockwise from the default position shown in FIG. 24A such that a particular chamber is aligned with one of the apertures 1014c formed in the bottom portion 1014b of the scent mixing chamber 1014, for example.

TABLE 6

| Chamber | Orientation | Orientation of Center | |
|---|---|---|---|
| Number | Identifier | of Chamber | Relative Steps |
| 1 | 000 | 0° | 0 |
| 2 | 001 | 72° | 40 |
| 3 | 010 | 144° | 80 |
| 4 | 011 | 216° | 120 |
| 5 | 100 | 288° | 160 |

Table 7 shows a table similar to Table 6 that is for clockwise rotation. Information corresponding to Table 7 may be stored in internal memory of the microcontroller.

TABLE 7

| Chamber | Orientation | Orientation of Center | |
|---|---|---|---|
| Number | Identifier | of Chamber | Relative Steps |
| 1 | 000 | 0° | 0 |
| 2 | 001 | 288° | 160 |
| 3 | 010 | 216° | 120 |
| 4 | 011 | 144° | 80 |
| 5 | 100 | 72° | 40 |

The processing performed at 2308 will be explained with reference to a series of calculations performed by the scent dispensing device 1602 in response to receiving a scent specification corresponding to a scent specification file, for example, generated using the scent sequence specification user interface 2000 shown in FIG. 20 and described above. The scents specified in a sequence of scent specifications require the first scent dispensing device 1602 to determine corresponding orientations of the scent cartridge 2400. For example, the scent cartridge 2400 is initially a default or first orientation or position shown in FIG. 24A, the first scent dispensing device 1602 determines a second orientation of the scent cartridge 2400 corresponding to FIG. 24B, and then a third orientation of the scent cartridge 2400 corresponding to FIG. 24C.

As noted above, the scent cartridge 2400 initially is in the default orientation shown in FIG. 24A, and the first scent dispensing device 1602 determines the second orientation corresponding to FIG. 24B. For example, the scent specification includes information indicating that the aperture corresponding to chamber number 4 of the scent cartridge 2400 is to be aligned with aperture 1014c formed in the bottom portion 1014b of the scent mixing chamber 1014. The microcontroller first determines the amount of rotation required if the scent cartridge 2400 is rotated in a clockwise direction and the amount of rotation required if the scent cartridge 2400 is rotated in a counterclockwise direction. That is, the microcontroller determines that the scent cartridge 2400 shown in FIG. 24A must be rotated by 144° (or 80 steps) in the clockwise direction, or alternatively must be rotated by 216° (or 120 steps) in the counterclockwise direction, for the scent cartridge 2400 to become oriented as shown in FIG. 24B. Because less rotation of the scent cartridge 2400 is required in the clockwise direction (e.g., fewer steps), the microcontroller determines at 2308 that the direction of movement is the clockwise direction, and that the amount of movement is 144° (or 80 steps).

At 2310, the microcontroller controls the motor coupled to the scent cartridge 2400 to move in the direction of movement determined at 2308, by the amount of movement determined at 2308. For example, the microcontroller 1702 provides control signals to the stepper motor 1704a that cause the shaft of the stepper motor 1704a to move 80 steps in the clockwise direction to orient the scent cartridge 2400 as shown in FIG. 24B.

At 2312, the microcontroller starts an internal timer. In one embodiment, the microcontroller initializes the timer started at 2312 using a default timer value (e.g., 5000 milliseconds). In another embodiment, the microcontroller initializes the timer started at 2312 using a timer value (e.g., 10 seconds) that is included in the scent specification received at 2302.

At 2314, the microcontroller determines whether the timer has expired. For example, the microcontroller monitors the timer for a predetermined voltage level that indicates that the amount of time used to initialize the timer has elapsed after the timer was set at 2312. If the microcontroller 1702 determines that the timer has not expired, the method returns to 2314. If the microcontroller 1702 determines that the timer has expired, the method proceeds to 2316.

At 2316, the microcontroller determines whether an additional scent specification has been received. For example, the microcontroller performs the same acts as described above in connection with 2302. If the microcontroller determines that the additional scent specification has been received, the method returns to 2306.

For example, at 2306, the microcontroller determines that the indication of the stop condition has not been received and proceeds to 2308. At 2308, the microcontroller determines the third orientation corresponding to FIG. 24C. For example, the scent specification includes information indicating that the aperture corresponding to chamber number 3 of the scent cartridge 2400 is to be aligned with aperture 1014c formed in the bottom portion 1014b of the scent mixing chamber 1014. The microcontroller determines the amount of rotation required if the scent cartridge 2400 is rotated in the clockwise direction and the amount of rotation required if the scent cartridge 2400 is rotated in the counterclockwise direction. That is, the microcontroller determines that the scent cartridge 2400 shown in FIG. 24B must be rotated by 72° (or 40 steps) in the clockwise direction, or alternatively must be rotated by 288° (or 160 steps) in the counterclockwise direction, for the scent cartridge 2400 to become oriented as shown in FIG. 24C. Because less rotation of the scent cartridge 2400 is required in the clockwise direction, the microcontroller determines at 2308 that the direction of movement is the clockwise direction, and that the amount of movement is 72° (or 40 steps). The microcontroller then performs the acts described above at 2310, 2312, and 2314.

At 2316, if the microcontroller determines that the additional scent specification has not been received, the method proceeds to 2318. At 2318, the microcontroller returns each cartridge that was moved based on the controlling performed at 2310 to its default orientation or position. For example, if the cartridge 2400 is currently oriented/positioned as shown in FIG. 24C, the microcontroller causes the cartridge 2400 to be oriented/positioned as shown in FIG. 24A. That is, the microcontroller performs processing similar to that performed at 2308 and 2310 to cause the cartridge 2400 to be oriented/positioned as shown in FIG. 24A.

At 2318, the microcontroller causes the fan to stop operating. For example, the microcontroller 1702 provides a control signal to the fan 1708 that causes the fan 1708 to turn off.

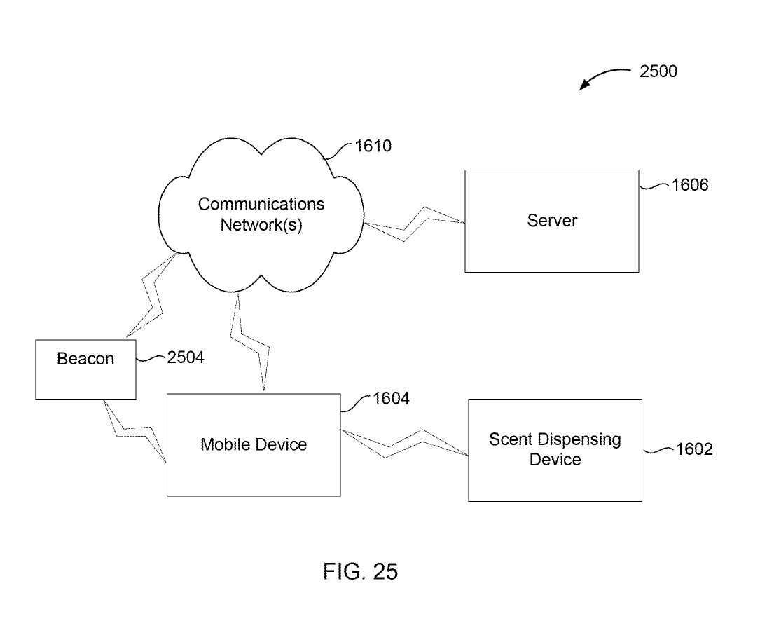

FIG. 25 is a network diagram of a scent dispensing system 2500, according to one illustrated embodiment. The scent dispensing system 2500 is similar in many respects to the scent dispensing system 1600 of FIG. 16, so much of the discussion of the scent dispensing system 1600 applies to the scent dispensing system 2500 as well.

The mobile device 1604 of the scent dispensing system 2500 is operative to communicate with a beacon 2504. The beacon 2504 is an electronic sensor device operative to transmit wireless signals and establish communications with client devices, such as the mobile device 1604. The beacon 2504 may be communicatively coupled to a server, such as the server 1606, via the communications network 1610, and functions as a wireless access point for the server, which may be located remotely.

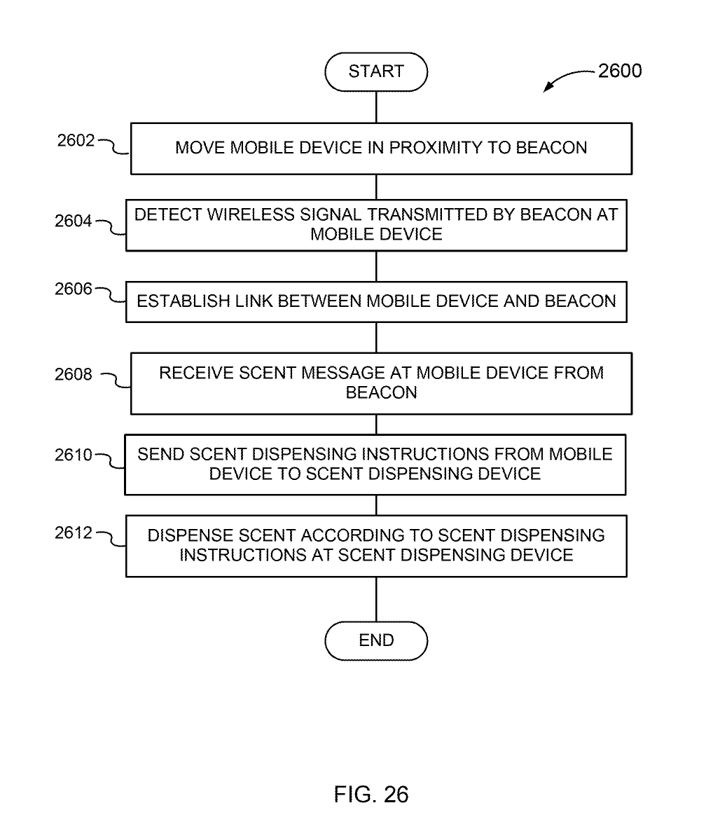

FIG. 26 is a flowchart of a method 2600 of operating the scent dispensing system 2500 of FIG. 25 using the beacon 2504, according to one illustrated embodiment. One or more acts included in the method 2600 may be performed by the mobile device 1604, the scent dispensing device 1602, the server 1606, and the beacon 2504.

The beacon 2504 may be positioned at a fixed location, for example, a fragrance section of a department store. At 2602, the user carries the mobile device 1604 and the scent dispensing device 1602 in proximity to the beacon 2504, for example, within the department store. From time to time the beacon 2504 transmits a short-range wireless signal (e.g., a Bluetooth® signal). At 2604, the program executing on the mobile device 1604 detects the wireless signal emitted by the beacon 2504. In response to detection of the wireless signal from the beacon 2504, a wireless communications link may be established between the mobile device 1604 and the beacon 2504 at 2606. In some embodiments, the wireless communication link is established using Bluetooth®, but other wireless protocols may be used. The beacon 2504 may then send a scent message over the communications link so that the scent message is received by the mobile device 1604 at 2608.

The scent message may include a scent specification file that includes instructions for dispensing one or more scents. Generally, a scent specification file is composed of a series of time-dependent instructions to enable a scent dispensing device to generate a desired set of scents. A scent specification file serves to depict the progression of the delivery of those scents. The modulation of scent can be a single scent which is released in a rhythmic pattern (e.g., timed pauses, or rests, between the releases of the scent), or a variety of layered scents which change and alternate over time. This progression of scents may be associated with a visual representation of the scent progression, shown to the user (e.g., using a display of a mobile device, such as a phone or tablet computer). The scent specification file may also assign the appropriate wired or wireless signals (e.g., Bluetooth®), so that if the application is linked to the scent dispensing device, the proper signals will be transmitted for the scent progression to be released.

In some embodiments, the scent message may be accompanied by one or more text, video, and/or audio portions directed to the user of the mobile device 1604. For example, the beacon 2504 may send a message to the mobile device 1604 requesting a selection of one or more scents by the user. As another example, the beacon 2504 may send one or more messages to the mobile device 1604 including promotional offers, directions to the fragrance department or other location, product information, or other types of messages.

At 2610, the program executing on the mobile device 1604 may provide scent dispensing instructions to the scent dispensing device 1602 using the scent specification file received from the beacon 2504. As discussed above, the mobile device 1604 may be communicatively coupled to the scent dispensing device 1602 by a wired or wireless communications interface (e.g., Bluetooth®, USB, etc.). At 2612, the scent dispensing device 1602 dispenses one or more scents according to the scent dispensing instructions.

Using the beacon 2504, retailers may be able to reach customers located proximate to retail locations by providing customers with scents that correspond to particular products. For example, a coffee shop may provide beacons that instruct scent dispensing devices located outside the coffee shop to dispense coffee scents. Similarly, a fragrance retailer may provide beacons that instruct scent dispensing devices to dispense scents that correspond to particular fragrances. Accordingly, the beacon 2504 may function as an advertising mechanism that engages customers' olfactory sense in addition to or instead of engaging their visual and audio senses.

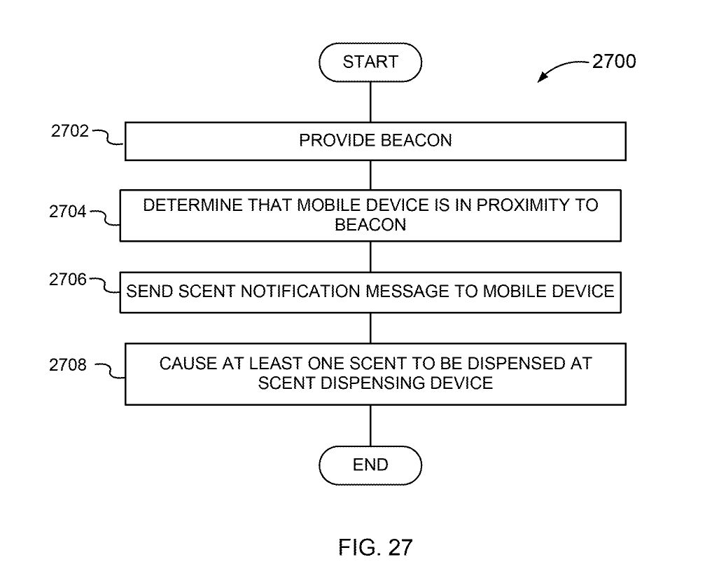

FIG. 27 is a flowchart of a method 2700 of operating the scent dispensing system 2500 of FIG. 25 using the beacon 2504, according to one illustrated embodiment. One or more acts included in the method 2700 may be performed by the mobile device 1604, the scent dispensing device 1602, the server 1606, and the beacon 2504.

At 2702, a beacon is provided in a fixed location. The beacon may be positioned at any suitable location, such as a restaurant, coffee shop, shopping center, or the like. Generally, the beacon may be positioned at a location near areas where potential users may be found. In some embodiments, numerous beacons may be provided that are spaced apart from each other at one or more venues. For example, a department store may position numerous beacons near entrances to the department store, within a shopping center attached to the department store, and/or at various locations within the department store.

At 2704, a computing device operatively coupled to the beacon (e.g., the server 1606) determines that a mobile device is in proximity to the beacon. As discussed above, from time to time the beacon may transmit a short-range wireless signal (e.g., a Bluetooth® signal). The program executing on the mobile device detects the wireless signal emitted by the beacon. In response to detection of the wireless signal from the beacon, the mobile device may send a signal to the beacon signifying that the mobile device is near the beacon. In some embodiments, responsive to detection of the wireless signals from the beacon, the mobile device may send a signal to the server through a communications network that bypasses the beacon. For example, the mobile device may send a signal to the server using a cellular network, Wi-Fi, or the like. In some embodiments, the mobile device and the beacon communicate using Bluetooth®, but other wireless protocols may be used.

In some embodiments, the beacon and/or the server may utilize one or more other location determination methods to determine that a mobile device is in proximity to the beacon. For example, a global positioning system (GPS) and/or a wireless network may be used to detect a mobile device's location, in addition to or instead of using the beacon.

At 2706, a scent notification message is sent to the mobile device. The scent notification message may include a text portion, audio portion, or a video portion. The scent notification message may operate to notify the user of the mobile device that one or more scents are available to be experienced by the user at a scent dispensing device.

For example, a scent notification message may be sent to a mobile device as the user thereof walks past an entrance to a department store. The scent notification message may notify the user that a sample scent for a fragrance sold by the department store is available to be experienced by the user at a scent dispensing device. In some embodiments, the scent dispensing device may be located within the department store. In other embodiments, the scent dispensing device may be located remotely from the department store.

The scent notification message may provide instructions for the user to locate the scent dispensing device so that the user can experience the scent indicated in the scent notification message. In some embodiments, multiple scent dispensing devices may be provided, and the scent notification message may provide the user with instructions to locate the nearest scent dispensing device. The location instructions may be in any suitable format. In some embodiments, text instructions are provided. In some embodiments, one or more maps are provided. A navigation application may also be used to present navigation instructions on the mobile device to the user.

The scent notification message may also provide advertising information or product information that is presented to the user on the user's mobile device. This information may be used to persuade the user to travel to the scent dispensing device to experience the available scent.

Once the user has reached a scent dispensing device, at least one scent is caused to be dispensed at the scent dispensing device at 2708. Continuing with the above example, after receiving a scent notification message indicating a scent corresponding to a fragrance is available, the user may travel to a scent dispensing device located within a shopping center to experience the scent. When the user is located at the scent dispensing device, the scent dispensing device may dispense the advertised scent for the user. Thus, the user may virtually experience the fragrance without actually having to obtain a quantity of the product.

In some embodiments, it may be desirable to provide a scent dispensing device at one or more locations remote from locations where an advertised product is sold. This allows users to experience the scent of a product when the product is not physically present.

Several mechanisms may be used to detect when the user is located at the scent dispensing device and ready to receive a scent therefrom. In some embodiments, the scent dispensing device includes one or more physical inputs (e.g., buttons) that may be activated by the user. The scent dispensing device may also include a proximity sensor that senses when the user is near the scent dispensing device. In some embodiments, the location of the user's mobile device may be used to track the location of the user and to determine when the user is near the scent dispensing device.

After experiencing one or more scents dispensed from the scent dispensing device, the user may wish to purchase a product associated with the one or more scents. In some embodiments, the user is provided with a graphical user interface to facilitate purchase of a product. For example, a graphical user interface may be provided through a Web site, or through an application executed by a processor of the user's mobile device. In some embodiments, the user may be provided with instructions regarding how the user can purchase the product (e.g., nearest stores, online stores, etc.).

The server or other device may store a unique device identifier and/or a unique user identifier for each device and/or user, respectively. For example, the server may store the International Mobile Subscriber Identity (IMSI) number for a mobile device to uniquely identify the mobile device. As another example, the server may store a user's name, phone number, account number, or other information related to the user that can be used to uniquely identify the user.

In some embodiments, the server may be configured to send scent notification messages to particular users identified by their respective unique identifier. For example, a user may be known to prefer a certain type of product, so messages sent to the user may be tailored to that user's particular preferences.

As another example, the scent dispensing device or a computing device associated with the scent dispensing device identify the user prior to dispensing a scent. In some embodiments, the scent dispensing device or a computing device associated with the scent dispensing device detects the identity of a user using a unique identifier readable from the user's mobile device. The identifier may include an IMSI number, a user account number, or any other type of identifier. The scent dispensing device may be controlled to dispense a scent dependent on the unique identifier.

In some embodiments, the user may be provided with a code that can be entered via a graphical user interface associated with the scent dispensing device. For example, the scent notification message may include a code that the user can type into a graphical user interface of a computing device, which causes the scent dispensing device to dispense a particular scent dependent on the code entered by the user.

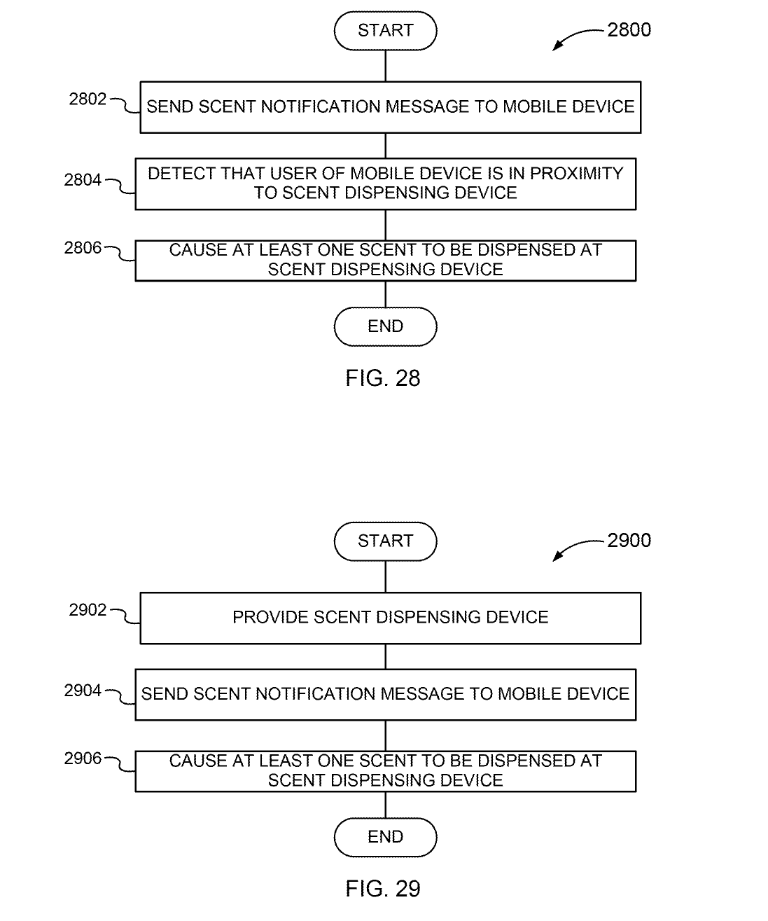

FIG. 28 is a flowchart of a method 2800 to provide a scent to a user. One or more acts included in the method 2800 may be performed by the mobile device 1604, the scent dispensing device 1602, and the server 1606.

At 2802, a scent notification message is sent to a mobile device. As an example, a processor of the server 1606 may execute an application that causes the scent notification message to be sent to the mobile device 1604. The scent notification message may be in any suitable form. For example, in some embodiments the scent notification messages is in the form of a text message, email message, a message within an application that executes on a processor of the mobile device, or the like. The scent notification message may include a text portion, audio portion, and/or a video portion.

The scent notification message may notify a user of the mobile device that a scent is available at a scent dispensing device. In some embodiments, the scent notification message may notify the user that a scent is available at a scent dispensing device located nearest to the user. In some embodiments, the user may be provided with a selection of one or more scent dispensing devices available to dispense the scent. As discussed above, the scent notification message may provide the user with instructions for navigating to one or more scent dispensing devices.

At 2804, the server or other device may detect that the user's mobile device (and thus the user) is in proximity to a scent dispensing device. In some embodiments, the location of the mobile device is detected using a beacon (e.g., the beacon 2504), GPS, or other location detection system. In some embodiments, a user interface may be provided to detect that the mobile device of the user is in proximity to the scent dispensing device. For example, the scent dispensing device may include an input selectable by the user that provides a notification to the scent dispensing device to dispense a scent for the user. As another example, the user may signal that he or she is near the scent dispensing device and ready for a scent to be dispensed via a user interface on the user's mobile device or on another computing device that communicates with the scent dispensing device. As another example, the scent dispensing device may include a motion or proximity sensor to automatically detect when the user is near the scent dispensing device.

At 2806, responsive to detecting the user is in proximity to the scent dispensing device and ready for a scent to be dispensed, the scent dispensing device is controlled to dispense at least one scent.

FIG. 29 is a flowchart of a method 2900 to provide a scent to users. One or more acts included in the method 2900 may be performed by the mobile device 1604, the scent dispensing device 1602, and the server 1606.

At 2902, a scent dispensing device is provided. The scent dispensing device may be provided in any suitable location wherein targeted users may be found. At 2904, the server sends a scent notification message to a mobile device. The scent notification message notifies the user of the mobile device that at least one scent is available to be experienced at the scent dispensing device. At 2906, the scent dispensing device is operated to cause at least one scent to be dispensed. For example, a coffee shop may provide a scent dispensing device at a location, such a sidewalk. The scent dispensing device may dispense scents relating to one or more types of coffee offered by the coffee shop. A computing device associated with the coffee shop may send scent notification messages to a plurality of users. For example, scent notification messages may be sent to users that have subscribed to an email list, users that follow the coffee shop via one or more social media applications, users that have downloaded an application associated with the coffee shop, or other users that the coffee shop wishes to notify. The scent notification message may notify the users that one or more scents are available to be dispensed at the scent dispensing device provided at the location. As discussed above, in some embodiments the scent dispensing device may be positioned at a location remote from the products associated with the scents dispensed by the scent dispensing device. In some embodiments, multiple scent dispensing devices are provided, and the users may be directed to a scent dispensing device located nearest them.

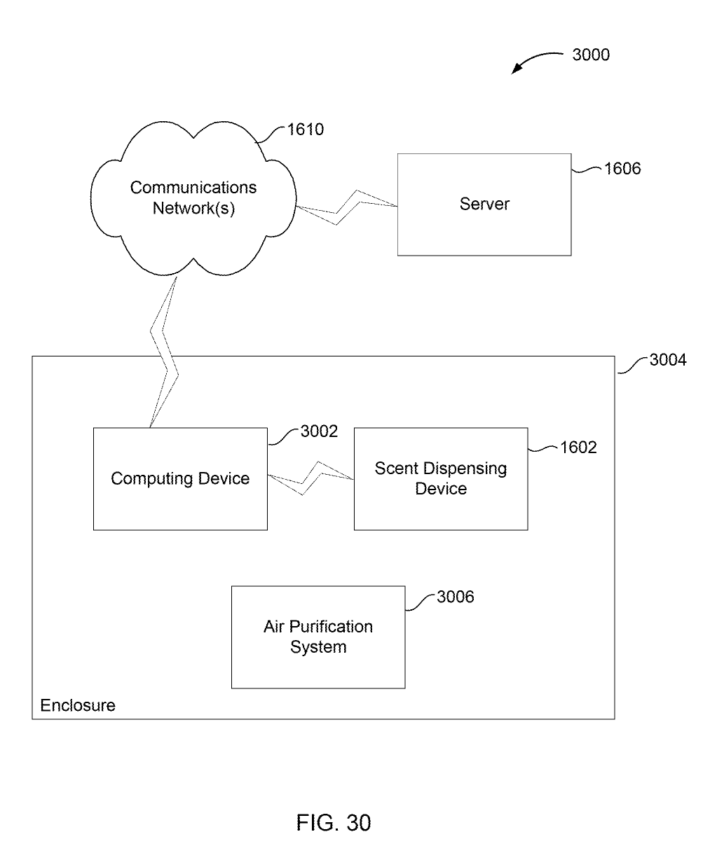

FIG. 30 is a diagram of a scent dispensing system 3000, according to one illustrated embodiment. The scent dispensing system 3000 includes a kiosk enclosure 3004 sized and dimensioned to accommodate a human user. For example, the enclosure may resemble a conventional telephone booth that includes has a door openable and closable by a user. When a user is inside the enclosure 3004, a substantially closed volume is defined. The enclosure 3004 may be located outdoors (e.g., on a sidewalk), or within another enclosed space (e.g., within a retail shop or department store).

A scent dispensing device 1602 is disposed within the enclosure 3004. The scent dispensing device 1602 dispenses one or more scents inside the enclosure 3004 that may be experienced by one or more users positioned within the enclosure.

The scent dispensing system 3000 also includes a computing device 3002. The computing device 3002 may have the same or similar components as the computing device 1800 of FIG. 18. The computing device 3002 is operatively coupled to the scent dispensing device 1602 and operates to control the dispensing of one or more scents by the scent dispensing device. In some embodiments, the computing device 3002 may be operatively coupled to the server 1606 via the communications network 1610. The computing device 3002 may be a device fixedly or removably attached to the enclosure 3004, or the computing device may be physically separated from the enclosure 3004. In some embodiments, the computing device 3002 is a mobile device (e.g., a phone, tablet computer, etc.) that communicates with the scent dispensing device 1602 via short-range wireless signals (e.g., Bluetooth®).

In some embodiments the scent dispensing system 3000 includes an air purification system 3006 that purifies air within the enclosure 3004. The air purification system 3006 may include one or more fans, filters, heat sources, light sources, porous materials (e.g., activated carbon), and the like, to remove particulates from the air within the enclosure 3004. In some embodiments, the air purification system 3006 may be operated before or after scents are dispensed by the scent dispensing device 1602 to provide an unscented environment for users to experience scents subsequently dispensed by the scent dispensing device.

In at least one embodiment, the scent dispensing device 1602 and the computing device 3002 may be provided as a kiosk without the enclosure 3004. For example, the scent dispensing device and the computing device may be provided in a kiosk structure similar in size and dimensions to an automated teller machine or a vending machine. In these embodiments, the computing device 3002 may be a custom computing device or a commercially available computing device, as discussed above.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments. For example, instead of starting operation of the fan at 2304, the first scent dispensing device 1602 may start operation of the fan after the one or more scent cartridges are oriented at 2310. Additionally, instead of stopping operation of the fan at 2320, the first scent dispensing device 1602 may stop operation of the fan before returning each of the one or more scent cartridges to the default position at 2318.

In addition, the first scent dispensing device 1602 may include a display device and a user input device (e.g., a touch screen) that enables a user to specify scents and/or durations of scents to be dispensed by the first scent dispensing device 1602 (e.g., without receiving any message from the first mobile device 1604). The microcontroller of the first scent dispensing device 1602 may store instructions that cause the first scent dispensing device 1602 to perform the method shown in FIG. 21. Additionally, the microcontroller of the first scent dispensing device 1602 may store instructions that cause the first scent dispensing device 1602 to display a selectable icon that, when selected, causes the microcontroller to display a user interface that enables a user to specify scents to be dispensed by the first scent dispensing device 1602. For example, the user interface may include a plurality of selectable icons, wherein each selectable icon includes an identifier of the scent medium 1234 included in one of the chambers 1232 of one of the scent cartridges loaded in the first scent dispensing device 1602. In response to one or more of the icons being selected, the microcontroller causes a corresponding scent or scent combination to be dispensed for a predetermined or a user-specified amount of time.

U.S. provisional patent application Ser. No. 61/944,870 filed Feb. 26, 2014, is incorporated herein by reference, in its entirety.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method to provide a scent to a user, the method comprising:
moving a client device in proximity to a beacon that transmits a short-range wireless signal, the client device communicates with a scent dispensing device over a scent dispensing device communications interface;
detecting the short-range wireless signal transmitted by the beacon at the client device using a short-range wireless communications interface;
establishing a link over the short-range wireless communications interface between the client device and the beacon; and
receiving a scent specification file from the beacon at the client device over the link, the scent specification file specifying at least one scent.

2. The method of claim 1, further comprising:
causing scent dispensing instructions to be sent from the client device to the scent dispensing device based on the scent specification file over the scent dispensing device communications interface, the scent dispensing instructions usable by the scent dispensing device to dispense the specified at least one scent.

3. The method of claim 2 wherein causing the scent dispensing instructions to be sent from the client device to the scent dispensing device over the scent dispensing device communications interface comprises causing the scent dispensing instructions to be sent wirelessly.

4. The method of claim 1 further comprising:
receiving a message from the beacon at the client device over the link, the message comprising at least one of advertising information or product information.

5. A method to provide a scent to a user, the method comprising:
providing a beacon that transmits a short-range wireless signal using a short-range wireless communications interface;
determining that a mobile device is in proximity to the beacon; and
sending a scent notification message wirelessly to the mobile device, the scent notification message providing a notification for a user of the mobile device that at least one scent is available to be experienced by the user.

6. The method of claim 5, further comprising:
causing the at least one scent to be dispensed at a scent dispensing device so that the at least one scent is experienced by the user.

7. The method of claim 5 wherein sending a scent notification message comprises sending a scent notification message that includes instructions for the user to locate a scent dispensing device.

8. The method of claim 5 wherein determining that the mobile device is in proximity to the beacon comprises:
transmitting a short-range wireless signal from the beacon; and
receiving a short-range wireless signal at the beacon from the mobile device responsive to transmitting the short-range wireless signal from the beacon.

9. The method of claim 5 wherein determining that the mobile device is in proximity to the beacon comprises:
detecting a location of the mobile device using a global positioning system (GPS) associated with the mobile device.

10. A method to provide a scent to a user, the method comprising:
sending a scent notification message wirelessly to a mobile device, the scent notification message providing a notification for a user of the mobile device that at least one scent is available to be experienced by the user;
detecting that the user is in proximity to a scent dispensing device; and
causing the scent dispensing device to dispense the at least one available scent.

11. The method of claim 10 wherein sending a scent notification message wirelessly comprises sending a text message to the mobile device.

12. The method of claim 10 wherein sending a scent notification message wirelessly comprises sending a notification message through an application installed on a data storage of the mobile device.

13. The method of claim 10 wherein detecting that the user is in proximity to a scent dispensing device comprises receiving a signal at the scent dispensing device from the mobile device of the user.

14. The method of claim 10 wherein detecting that the user is in proximity to a scent dispensing device comprises receiving a code at the scent dispensing device from the user of the mobile device.

15. The method of claim 10 wherein detecting that the user is in proximity to a scent dispensing device comprises detecting a location of the mobile device using a global positioning system (GPS) associated with the mobile device.

16. The method of claim 10 wherein sending a scent notification message wirelessly comprises sending a scent notification that includes instructions for locating the scent dispensing device.

17. The method of claim 10 wherein sending a scent notification message wirelessly comprises sending a scent notification that includes at least one of advertising information or product information.

18. A method to provide a scent to a user, the method comprising:
providing a scent dispensing device that dispenses one or more scents;
sending a scent notification message wirelessly to a mobile device, the scent notification message providing a notification for a user of the mobile device that at least one scent is available to be experienced by the user at the scent dispensing device; and
causing the scent dispensing device to dispense the at least one available scent.

19. The method of claim 18 further comprising:
receiving location information for the mobile device;
wherein sending a scent notification message wirelessly to a mobile device comprises sending a scent notification message wirelessly to the mobile device dependent on the received location information.

20. The method of claim 19 wherein receiving location information for the mobile device comprises:
transmitting a short-range wireless signal from a beacon; and
receiving a short-range wireless signal at the beacon from the mobile device responsive to transmitting the short-range wireless signal from the beacon.

21. The method of claim 19 wherein receiving location information for the mobile device comprises:
receiving global positioning system (GPS) data associated with the mobile device.

22. The method of claim 18 wherein providing a scent dispensing device that dispenses one or more scents comprises:
providing an enclosed space; and
positioning the scent dispensing device within the enclosed space.

23. The method of claim 22, further comprising:
from time to time purifying the air in the enclosed space to remove one or more scents previously dispensed from the scent dispensing device.

24. The method of claim 18 wherein sending a scent notification message wirelessly to a mobile device includes sending a scent notification message that includes a code, the method further comprising:
receiving the code from at least one of the user or the mobile device; and
verifying the code;
wherein causing the scent dispensing device to dispense the at least one available scent comprises causing the scent dispensing device to dispense the at least one available scent dependent on a value of the code.

25. The method of claim 18, further comprising:
storing an identifier in a data storage, the identifier uniquely identifying at least one of the user or the mobile device.

26. An apparatus, comprising:
an enclosure sized and dimensioned to receive a human user therein;
a scent dispensing device positioned to dispense one or more scents within the enclosure;
a user interface comprising a display;
a processor operatively coupled to the user interface and the scent dispensing device; and
a computer-readable storage medium that stores instructions that, when executed by the processor, cause the processor to:
present an available scent identifier on the display of the user interface, the scent identifier specifying at least one scent;
receive a selection of the scent identifier via the user interface; and
cause the scent dispensing device to dispense the at least one scent specified by the selected scent identifier.

27. The apparatus of claim 26 wherein the processor is operatively coupled to the scent dispensing device via a short-range wireless interface.

28. The apparatus of claim 26 wherein the processor, user interface, and computer-readable storage medium are disposed in a first housing, and the scent dispensing device is disposed in a second housing different from the first housing.

29. The apparatus of claim 26 wherein the processor, user interface, and computer-readable storage medium are components of a mobile computing device.

30. The apparatus of claim 26, further comprising:
an air purification system that purifies the air within the enclosure to remove one or more scents dispensed by the scent dispensing device.

31. The apparatus of claim 26 wherein the scent identifier includes at least one of a text portion, video portion, or audio portion.

32. The apparatus of claim 26 wherein the scent identifier comprises an image of a product, and the at least one scent specified by the scent identifier is associated with the product.

33. The apparatus of claim 26, further comprising:
a wireless communications interface operatively coupled to the processor, wherein the instructions cause the processor to:
detect that a mobile device is located in proximity to the scent dispensing device; and
send a scent notification message wirelessly to the mobile device when the mobile device is located in proximity to the scent dispensing device, the scent notification message provides a notification for a user of the mobile device that at least one scent is available to be experienced by the user at the scent dispensing device.

34. A scent notification system, the system comprising:
a beacon that transmits short-range wireless signals;
a processor operatively coupled to the beacon and operatively coupled to a communications network; and
a computer-readable storage medium that stores instructions that, when executed by the processor, cause the processor to:
detect that a mobile device is in proximity to the beacon; and
send a scent notification message wirelessly to the mobile device over the communications network, the scent notification message provides a notification for a user of the mobile device that at least one scent is available to be experienced by the user.

35. The system of claim 34 wherein the instructions cause the processor to cause the at least one scent to be dispensed at a scent dispensing device so that the at least one scent is experienced by the user.

36. The system of claim 34 wherein the instructions cause the processor to send a scent notification message that includes instructions for the user to locate a scent dispensing device.

37. The system of claim 34 wherein the instructions cause the processor to:
transmit a short-range wireless signal from the beacon; and
receive a short-range wireless signal at the beacon from the mobile device responsive to transmitting the short-range wireless signal from the beacon.

38. A scent notification system, the system comprising:
a processor operatively coupled to a communications network; and
a computer-readable storage medium that stores instructions that, when executed by the processor, cause the processor to:
send a scent notification message wirelessly to a mobile device, the scent notification message providing a notification for a user of the mobile device that at least one scent is available to be experienced by the user;
detect that the user is in proximity to a scent dispensing device; and
cause the scent dispensing device to dispense the at least one available scent.

39. The system of claim 38 wherein the instructions cause the processor to:
send a text message to the mobile device.

40. The system of claim 38 wherein the instructions cause the processor to:
send a notification message through an application installed on a data storage of the mobile device.
